(19) United States
(12) Patent Application Publication
(10) Pub. No.: US 2026/0046827 A1
(43) Pub. Date: Feb. 12, 2026

(54) CONTROL METHOD FOR INFORMATION PROCESSING SYSTEM AND INFORMATION PROCESSING SYSTEM

(71) Applicant: SEIKO EPSON CORPORATION, Tokyo (JP)

(72) Inventor: Koichiro YANO, MATSUMOTO-SHI (JP)

(73) Assignee: SEIKO EPSON CORPORATION, Tokyo (JP)

(21) Appl. No.: 19/292,938

(22) Filed: Aug. 7, 2025

(30) Foreign Application Priority Data
Aug. 9, 2024 (JP) 2024-133923

(51) Int. Cl. H04W 64/00; G06Q 10/0833; H04W 4/029

(52) U.S. Cl. CPC H04W 64/00; H04W 4/029; G06Q 10/0833

(57) ABSTRACT

A control method for an information processing system including a first terminal acquiring first location information, a second terminal acquiring second location information, and a server setting, according to communication with the first terminal, as a specific area, an incommunicable area where communication with the second terminal is not performed or a communicable area where communication with the second terminal is performed.

The present application is based on, and claims priority from JP Application Serial Number 2024-133923, filed Aug. 9, 2024, the disclosure of which is hereby incorporated by reference herein in its entirety.

### BACKGROUND

### 1. Technical Field

The present disclosure relates to a control method for an information processing system and an information processing system.

### 2. Related Art

For example, a tracker terminal is mounted on a vehicle or the like and the location of the tracker terminal is managed by a server.

In the technique described in WO 2009/157076, a communication environment of a network at a location of a vehicle is determined by a server unit based on the intensity of a global positioning system (GPS) signal received by a communication environment prediction unit mounted on the vehicle (see WO 2009/157076).
WO 2009/157076 is an example of the related art.

However, in the related art explained above, although the communication environment of the network is determined using the intensity of the GPS signal received by the communication environment prediction unit, for example, even if the intensity of the GPS signal received from the GPS satellite is sufficient, the communication environment of the network is not always good. For this reason, in the communication environment prediction unit explained above, when it is erroneously determined based on the intensity of the received GPS signal that the environment of the network is good, there is a problem in that power consumed by the communication environment prediction unit increases because, for example, a communication failure in the network occurs.

### SUMMARY

According to an aspect of the present disclosure, there is provided a control method for an information processing system including: a first terminal configured to acquire first location information; a second terminal configured to acquire second location information; and a server configured to set, according to communication with the first terminal, as a specific area, an incommunicable area where communication with the second terminal is not performed or a communicable area where communication with the second terminal is performed, the control method including: causing the first terminal to acquire the first location information; causing the first terminal to acquire communication information concerning communication with the server at a location indicated by the first location information; causing the first terminal to transmit a communication signal including, of the first location information and the communication information, at least the first location information to the server; causing the server to determine, based on the communication signal, whether communication at the location indicated by the first location information is possible or whether communication intensity satisfies a predetermined condition; causing the server to, in at least one of a case in which the server determines that a first condition that the communication is disallowed or the communication intensity is smaller than a predetermined value at the location indicated by the first location information is satisfied and a case in which the server determines that a second condition that the communication is allowed or the communication intensity is equal to or larger than the predetermined value at the location indicated by the first location information is satisfied, set the specific area including the location indicated by the first location information; causing the server to transmit area information including information concerning the set specific area to the second terminal; causing the second terminal to acquire the second location information; and at least one of, when the incommunicable area is set as the specific area including the location indicated by the first location information because the first condition is satisfied, causing the second terminal not to transmit the second location information to the server when the location indicated by the second location information is an inside of the incommunicable area or, when the communicable area is set as the specific area including the location indicated by the first location information because the second condition is satisfied, causing the second terminal to transmit the second location information to the server when the location indicated by the second location information is an inside of the communicable area.

According to an aspect of the present disclosure, there is provided a control method for an information processing system that sets, using a server, a first terminal, and a second terminal, in the second terminal, a specific area corresponding to communication between the first terminal and the server, the control method including: acquiring first location information of the first terminal; acquiring communication information concerning communication between the server and the first terminal at a location indicated by the first location information of the first terminal; in at least one of a case in which it is determined that a first condition that the communication is disallowed or communication intensity of the communication is smaller than a predetermined value at the location indicated by the first information is satisfied and a case in which it is determined that a second condition that the communication is allowed or the communication intensity is equal to or larger than the predetermined value at the location indicated by the first information, setting, according to the acquired communication information, the specific area including the location indicated by the first location information; and executing at least one of causing the second terminal not to perform communication with the server when the second terminal is located on an inside of an incommunicable area that is the specific area set because the first condition is satisfied and causing the second terminal to perform communication with the server when the second terminal is located on an inside of a communicable area.

According to an aspect of the present disclosure, there is provided an information processing system including: a first terminal configured to acquire first location information; a second terminal configured to acquire second location information; and a server configured to set, according to communication with the first terminal, as a specific area, an incommunicable area where communication with the second terminal is not performed or a communicable area where communication with the second terminal is performed, wherein the first terminal: acquires the first location information; acquires communication information concerning communication with the server at a location indicated by the first location information; and transmits a communication signal including, of the first location information and the communication information, at least the first location information to the server; the server: determines, based on the communication signal, whether communication at the location indicated by the first location information is possible or whether communication intensity satisfies a predetermined condition; in at least one of a case in which the server determines that a first condition that the communication is disallowed or the communication intensity is smaller than a predetermined value at the location indicated by the first location information is satisfied and a case in which the server determines that a second condition that the communication is allowed or the communication intensity is equal to or larger than the predetermined value at the location indicated by the first location information is satisfied, sets the specific area including the location indicated by the first location information; and transmits area information including information concerning the set specific area to the second terminal; and the second terminal: acquires the second location information; and executes at least one of, when the incommunicable area is set as the specific area including the location indicated by the first location information because the first condition is satisfied, not transmitting the second location information to the server when the location indicated by the second location information is an inside of the incommunicable area or, when the communicable area is set as the specific area including the location indicated by the first location information because the second condition is satisfied, transmitting the second location information to the server when the location indicated by the second location information is an inside of the communicable area.

### BRIEF DESCRIPTION OF THE DRAWINGS

FIG. 1 is a diagram illustrating a schematic configuration example of an information processing system according to an embodiment.

FIG. 2A is a diagram illustrating a schematic configuration example of a first tracker terminal according to the embodiment.

FIG. 2B is a diagram illustrating a configuration example of hardware of the first tracker terminal according to the embodiment.

FIG. 3 is a diagram illustrating a schematic configuration example of a second tracker terminal according to the embodiment.

FIG. 4A is a diagram illustrating a schematic configuration example of a server device according to the embodiment.

FIG. 4B is a diagram schematically illustrating an overview of storage information of the server according to the embodiment.

FIG. 5 is a diagram schematically illustrating an example of first terminal-related data in the first tracker terminal according to the embodiment.

FIG. 6A is a diagram schematically illustrating an example of circular region setting for setting communication area information including a communicable area and an incommunicable area according to the embodiment.

FIG. 6B is a diagram schematically illustrating an example of communication area information including the communicable area and the incommunicable area using a polygonal zone according to the embodiment.

FIG. 6C is a diagram schematically illustrating another example of the communication area information including the communicable area and the incommunicable area using the polygonal zone according to the embodiment.

FIG. 6D is a diagram schematically illustrating an example of communication area information including the communicable area and the incommunicable area using a circular zone according to the embodiment.

FIG. 7 is a diagram illustrating an example of a flow of processing at the time of upload from the first tracker terminal to the server according to the embodiment.

FIG. 8 is a diagram illustrating an example of a flow of processing at the time when the second tracker terminal acquires communication area information from the server according to the embodiment.

FIG. 9 is a diagram illustrating an example of delivery bases and directions among the bases according to the embodiment.

FIG. 10 is a diagram illustrating an example of a first table that associates an action history of a tracker terminal and a notification range of a communication area according to the embodiment.

FIG. 11 is a diagram illustrating an example of a flow of processing in which the server changes the notification range of the communication area according to the action history of the tracker terminal according to the embodiment.

FIG. 12 is a diagram illustrating an example of a second table that associates individual communication area identification information of the tracker terminal and a reference time according to the embodiment.

FIG. 13 is a diagram illustrating an example of a flow of processing of determining presence or absence of use of an individual communication area according to a reference time of an individual communication area in the tracker terminal according to the embodiment.

### DESCRIPTION OF EMBODIMENTS

An embodiment is explained below with reference to the drawings.

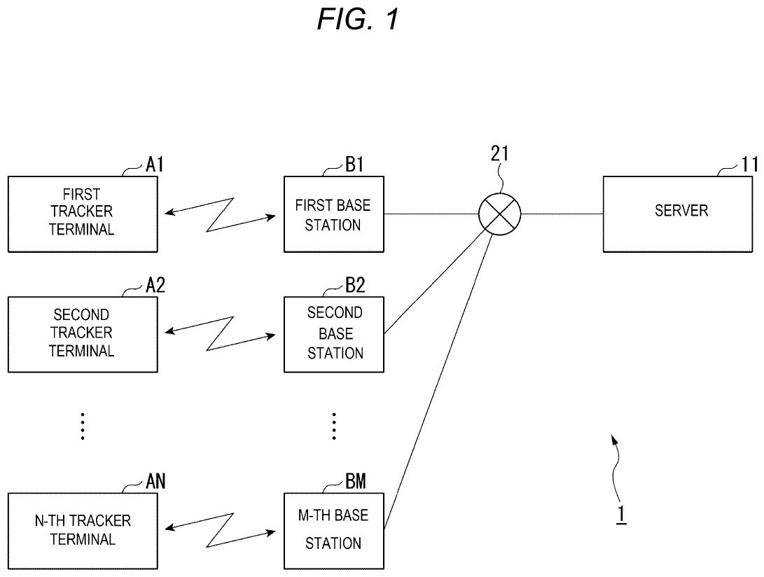

FIG. 1 is a diagram illustrating a schematic configuration example of an information processing system 1 according to the embodiment.

The information processing system 1 includes a first tracker terminal A1 to an N-th tracker terminal AN, which are a plurality of, that is, N tracker terminals, a server 11, a first base station B1 to an M-th base station BM, which are a plurality of, that is, M base stations, and a communication network 21.

Here, in the present embodiment, N is an integer of 2 or more.

In the present embodiment, M is an integer of 2 or more.

In the present embodiment, one server 11 is explained but, as another example, functions of the server 11 may be distributed and provided in a plurality of devices.

In the present embodiment, one communication network 21 is explained but, as another example, the communication network 21 may include a plurality of communication networks.

In the present embodiment, the first base station B1 to the M-th base station BM, which are the M base stations, are distributed and provided, and each of the first base station B1 to the M-th base station BM wirelessly communicates with a tracker terminal present in a communicable region of each of the base stations.

In the example illustrated in FIG. 1, in order to simplify the explanation, it is assumed that N and M are the same number, and each of the first tracker terminal A1 to the N-th tracker terminal AN communicate with each of the first base station B1 to the M-th base station BM by radio.

As another example, in a situation in which one base station is capable of communicating with all tracker terminals by radio, the number of base stations may be one.

Each of the first tracker terminal A1 to the N-th tracker terminal AN is, for example, mounted on each tracking target.

In the present embodiment, the tracking target is a vehicle such as a truck that performs delivery but is not limited thereto and may be another object or a living body. As an example, a technique according to the present embodiment may be applied to a child watching system and, in this case, each child is a tracking target and each of the first tracker terminal A1 to the N-th tracker terminal AN is given to each child.

As the wireless communication system including the first base station B1 to the M-th base station BM, any wireless communication system may be used and, as an example, a low power wide area (LPWA) system that is wide area communication may be used.

In the present embodiment, each of the first tracker terminal A1 to the N-th tracker terminal AN and the server 11 are capable of communicating via the communication network 21 and a base station. Each of the first tracker terminal A1 to the N-th tracker terminal AN and each of the first base station B1 to the M-th base station BM are capable of wirelessly communicating. Each of the first base station B1 to the M-th base station BM and the server 11 are capable of communicating via the communication network 21.

In the present embodiment, when receiving a signal transmitted from each of the first tracker terminal A1 to the N-th tracker terminal AN, the server 11 determines that each of the first tracker terminal A1 to the N-th tracker terminal AN is present in a communication environment in which data communication is possible.

In the present embodiment, when a signal transmitted from each of the first tracker terminal A1 to the N-th tracker terminal AN to the server 11 arrives at the server 11, a response signal from the server 11 or a response signal from a base station representing the server 11 is transmitted to each of the first tracker terminal A1 to the N-th tracker terminal AN that is a transmission source. Accordingly, when receiving the response signal, each of the first tracker terminal A1 to the N-th tracker terminal AN determines that the tracker terminal is present in a communication environment in which the tracker terminal is capable of performing data communication with the base station.

In the present embodiment, each of the first tracker terminal A1 to the N-th tracker terminal AN and the server 11 communicate via the base station. However, as another example, a configuration in which each of the first tracker terminal A1 to the N-th tracker terminal AN and the server 11 directly communicate may be used.

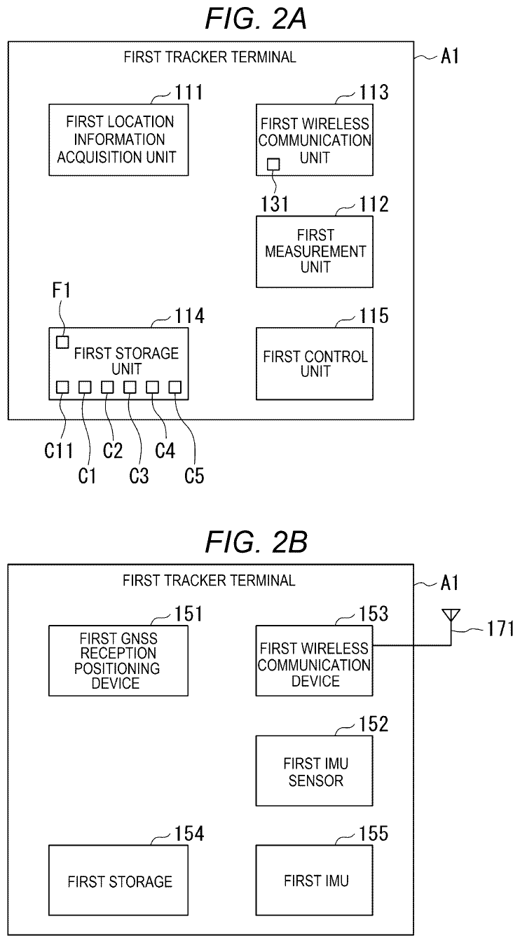

FIG. 2A is a diagram illustrating a schematic configuration example of the first tracker terminal A1 according to the embodiment.

The first tracker terminal A1 includes a first location information acquisition unit 111, a first measurement unit 112, a first wireless communication unit 113, a first storage unit 114, and a first control unit 115.

The first wireless communication unit 113 includes a first communication information acquisition unit 131.

The first location information acquisition unit 111 acquires first location information that is information concerning the location of the first tracker terminal A1.

Here, the first location information acquisition unit 111 has, for example, a function of a global navigation satellite system (GNSS), and acquires the first location information with the function.

In the present embodiment, a GPS satellite system is used as the GNSS system. However, not only this, but another satellite system may be used. For example, a satellite system such as BeiDou, GLONASS, Galileo, or QZSS may be used.

The first measurement unit 112 includes a predetermined sensor, measures a predetermined physical quantity with the sensor, and acquires a result of the measurement.

As the sensor, various sensors may be used. In the present embodiment, a sensor of an inertial measurement unit (IMU) is used.

The first wireless communication unit 113 has a function of performing wireless communication. In the present embodiment, the first wireless communication unit 113 has a function of performing wireless communication with each of the first base station B1 to the M-th base station BM. In the present embodiment, the first tracker terminal A1 and the server 11 communicate via the wireless communication.

The first communication information acquisition unit 131 acquires predetermined communication information concerning communication with the server 11. The communication information may be, for example, information capable of specifying at least one of possibility of communication and communication intensity.

Possibility of communication represents success of communication.

Impossibility of communication represents failure of communication.

Cancellation of communication may be used as an example of the communication information. In the present embodiment, cancellation of communication represents that communication has not been attempted and communication has not been performed.

For example, when the first tracker terminal A1 and the server 11 communicate via the base station, the communication intensity of wireless communication between the first tracker terminal A1 and the base station may be used as the communication intensity.

As an example, the intensity of a radio wave received by the first tracker terminal A1 from the base station may be used as the communication intensity.

The intensity of the radio wave may be referred to as intensity of a signal.

For example, when the first tracker terminal A1 communicates with the base station via a not-illustrated relay station, the communication intensity of wireless communication between the first tracker terminal A1 and the relay station may be used.

The first storage unit 114 stores information.

In the present embodiment, the first storage unit 114 stores first location information C1, first measurement information C2, first communication information C3, first area information C4, first action range information C5, a first control program C11, and first terminal-related data F1.

In the present embodiment, for convenience of explanation, the information stored in the first storage unit 114 is segmented. However, each piece of the information may not be clearly separated.

Here, the first location information C1 is first location information acquired by the first location information acquisition unit 111.

The first measurement information C2 is information concerning a measurement result acquired by the first measurement unit 112.

The first communication information C3 is communication information acquired by the first communication information acquisition unit 131.

The first area information C4 is information concerning a communication area.

The first action range information C5 is information concerning a range of an action of the first tracker terminal A1. In the present embodiment, the range of the action of the first tracker terminal A1 is equivalent to a range of an action of a tracking target on which the first tracker terminal A1 is mounted.

The first control program C11 is a program for performing various kinds of processing or control in the first tracker terminal A1.

The first control unit 115 performs various kinds of processing or control in the first tracker terminal A1.

In the present embodiment, the first control unit 115 includes a predetermined processor and executes the first control program C11 with the processor to perform various kinds of processing or control.

FIG. 2B is a diagram illustrating a configuration example of hardware of the first tracker terminal A1 according to the embodiment.

The first tracker terminal A1 includes a first GNSS reception positioning device 151, a first IMU sensor 152, a first wireless communication device 153, a first storage 154, and a first MCU155 that is a micro controller unit (MCU).

Here, a function of the first location information acquisition unit 111 is configured by the first GNSS reception positioning device 151.

A function of the first measurement unit 112 is configured by the first IMU sensor 152.

A function of the first wireless communication unit 113 is configured by the first wireless communication device 153.

A function of the first storage unit 114 is configured by the first storage 154.

A function of the first control unit 115 is configured by the first MCU155.

The configuration examples of the first tracker terminal A1 illustrated in FIGS. 2A and 2B are examples and a configuration of the first tracker terminal A1 is not limited thereto.

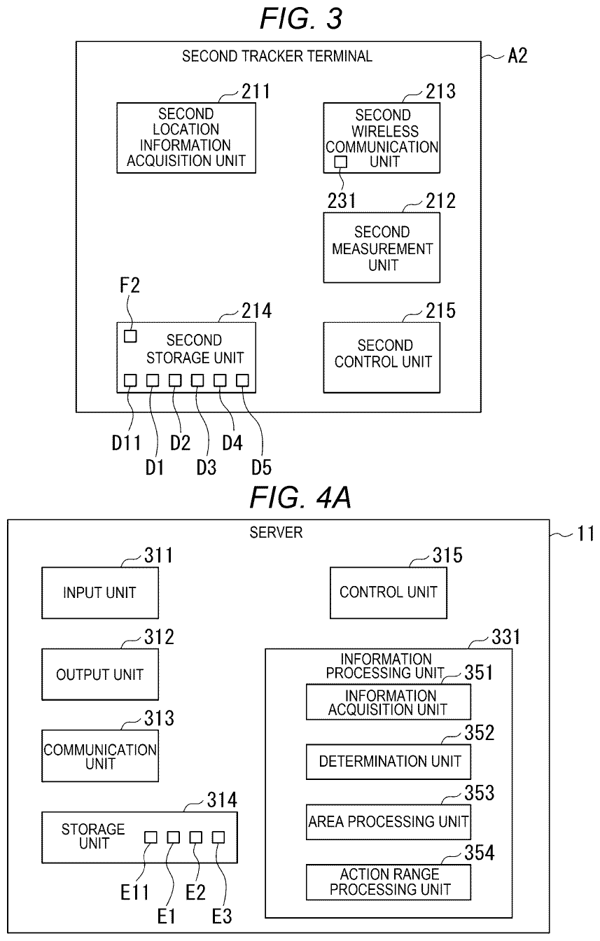

FIG. 3 is a diagram illustrating a schematic configuration example of the second tracker terminal A2 according to the embodiment.

The second tracker terminal A2 includes a second location information acquisition t 211, a second measurement unit 212, a second wireless communication unit 213, a second storage unit 214, and a second control unit 215.

The second wireless communication unit 213 includes a second communication information acquisition unit 231.

The second storage unit 214 stores second location information D1, second measurement information D2, second communication information D3, second area information D4, second action range information D5, a second control program D11, and second terminal-related data F2.

In the present embodiment, the configuration and operation of the second tracker terminal A2 are similar to those of the first tracker terminal A1. In the present embodiment, for convenience of explanation, a term “first” is added to the components of the first terminal A1 and a term “second” is added to the components of the second terminal A2 to distinguish the components of the first tracker terminal A1 and the components of the second tracker terminal A2.

A configuration of hardware of the second tracker terminal A2 is the same as, for example, the configuration of the hardware of the first tracker terminal A1 illustrated in FIG. 2B.

In the present embodiment, the first tracker terminal A1 to the N-th tracker terminal AN respectively have the same configuration and perform the same operation. However, other configurations may be used.

In the present embodiment, for convenience of explanation, the server 11 generates communication area information based on a communication situation for upload from the first tracker terminal A1 to the server 11 and the second tracker terminal A2 uses the communication area information provided from the server 11. However, for example, all of the first tracker terminal A1 to the N-th tracker terminal AN respectively functions of performing both of these operations.

That is, taking the first tracker terminal A1 and the second tracker terminal A2 as an example, for example, the first tracker terminal A1 may have a function of performing an operation of using communication area information provided from the server 11 and the second tracker terminal A2 may have a function of performing a communication operation for upload to the server 11.

For these reasons, the server 11 may generate communication area information based on, for example, a situation of communication with two or more tracker terminals among the first tracker terminal A1 to the N-th tracker terminal AN.

As an example, the server 11 may generate communication area information based on a situation of communication with all of the first tracker terminal A1 to the N-th tracker terminal AN.

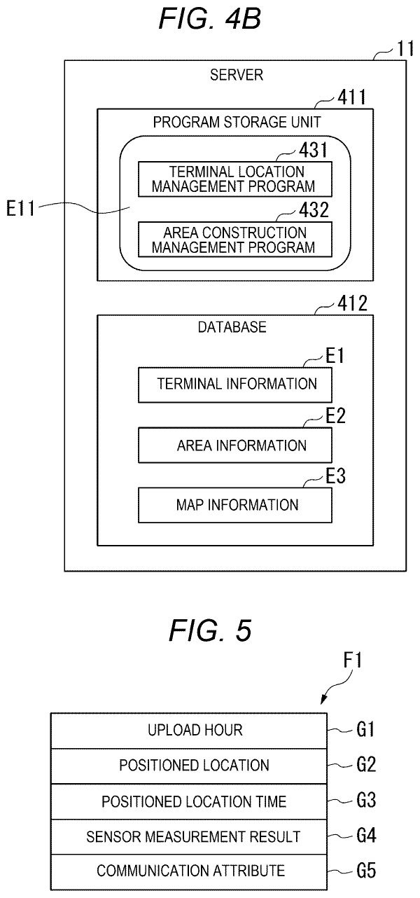

FIG. 4A is a diagram illustrating a schematic configuration example of the server 11 according to the embodiment.

In the present embodiment, the server 11 is configured using a computer.

The server 11 includes an input unit 311, an output unit 312, a communication unit 313, a storage unit 314, a control unit 315, and an information processing unit 331.

The information processing unit 331 includes an information acquisition unit 351, a determination unit 352, an area processing unit 353, and an action range processing unit 354.

The input unit 311 may have, for example, a function of inputting an instruction or the like based on operation performed by a not-illustrated user or may have a function of inputting information output from a not-illustrated external device.

The output unit 312 may have, for example, a function of displaying and outputting information concerning a display target on a not-illustrated display screen or a function of outputting sound information to a not-illustrated speaker or may have a function of outputting information to a not-illustrated external device.

The communication unit 313 has a function of performing communication.

In the present embodiment, the communication unit 313 is capable of communicating with each of the first tracker terminal A1 to the N-th tracker terminal AN via the communication network 21 and the base station.

Note that, in the present embodiment, the communication unit 313 is explained separately from the input unit 311 and the output unit 312. However, for example, a function of a reception unit among functions of the communication unit 313 may be included in functions of the input unit 311 and a function of a transmission unit among the functions of the communication unit 313 may be included in functions of the output unit 312.

The storage unit 314 stores information.

In the present embodiment, the storage unit 314 stores terminal information E1, area information E2, map information E3, and a control program E11.

Note that, in the present embodiment, for convenience of explanation, the information stored in the storage unit 314 is segmented. However, each piece of information may not always be clearly separated.

The terminal information E1 is information concerning each of the first tracker terminal A1 to the N-th tracker terminal AN.

The terminal information E1 may include, for each of the first tracker terminal A1 to the N-th tracker terminal AN, for example, identification information for each terminal, location information, and information concerning a communication situation.

The terminal information E1 may include, for example, information concerning a tracking target on which each of the first tracker terminal A1 to the N-th tracker terminal AN is mounted and may include, for example, information concerning an action range of the tracking target.

The area information E2 includes information concerning areas to which the first tracker terminal A1 to the N-th tracker terminal AN can move.

As the areas to which the first tracker terminal A1 to the N-th tracker terminal AN can move, for example, an area of the entire world, an area of the entire Japan, or an area of a predetermined region may be used.

In the present embodiment, the area information E2 includes communication area information concerning whether communication for upload from the tracker terminal to the server 11 is possible. The communication area information includes, for example, one or both of information concerning a communicable area indicating an area where communication is possible and information concerning an incommunicable area indicating that communication is impossible.

In the present embodiment, the communicable area and the incommunicable area are sometimes referred to as specific areas. However, in a configuration in which only one of the communicable area and the incommunicable area is used, the specific area represents the one.

The map information E3 includes information concerning a map covering an area managed by the area information E2.

Here, any map information may be used as the map information.

In the present embodiment, the area is managed using the map information. However, as another example, the area may be managed without using the map information. In this case, the map information E3 may not be stored in the server 11.

The control program E11 is a program for performing various kinds of processing or control in the server 11.

The control unit 315 performs various kinds of processing or controls in the server 11.

In the present embodiment, the control unit 315 includes a predetermined processor such as a central processing unit (CPU) and performs various kinds of processing or control by executing the control program E11 with the processor.

The information processing unit 331 performs predetermined information processing.

The information acquisition unit 351 acquires information necessary for information processing.

The information acquisition unit 351 acquires, for example, information stored in the storage unit 314, information received by the communication unit 313, or information input by the input unit 311.

The determination unit 352 performs predetermined determination.

In the present embodiment, the determination unit 352 may determine, for example, whether communication is possible or whether communication intensity is equal to or larger than a predetermined value.

The area processing unit 353 performs processing concerning an area.

In the present embodiment, the area processing unit 353 may perform, for example, processing for setting a communicable area or r an incommunicable area and processing for updating the communicable area or the incommunicable area.

The action range processing unit 354 performs processing concerning an action range of a tracker terminal.

In the present embodiment, the action range processing unit 354 may perform processing for specifying an action range for each of the first tracker terminal A1 to the N-th tracker terminal AN. For example, this specifying may not always be strict specifying and may be specifying by estimation.

FIG. 4B is a diagram schematically illustrating an overview of storage information of the server 11 according to the embodiment.

In the server 11, the program storage unit 411 stores a terminal location management program 431 and an area construction management program 432 as the control program E11.

In the server 11, the terminal information E1, the area information E2, and the map information E3 are stored in a database 412.

The terminal location management program 431 is a program for managing the location of each of the first tracker terminal A1 to the N-th tracker terminal AN.

The area construction management program 432 is a program for constructing a specific area and managing the specific area.

The configuration examples of the server 11 illustrated in FIGS. 4A and 4B are examples and a configuration of the server 11 is not always limited thereto.

For example, the configuration of the information processing unit 331 illustrated in FIG. 4A is an example for explanation. Functional units of each kind of information processing may not be clearly separated.

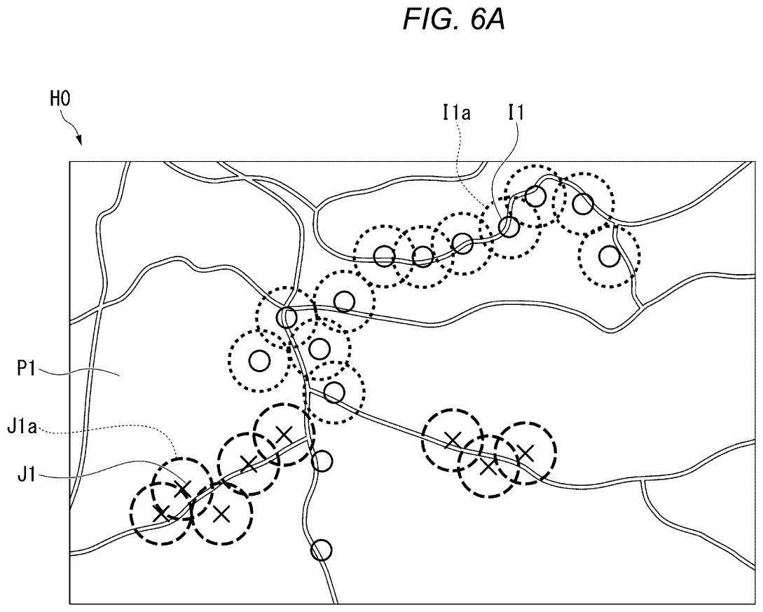

FIG. 5 is a diagram schematically illustrating an example of the first terminal-related data F1 in the first tracker terminal A1 according to the embodiment.

A name “terminal-related data” is for convenience of explanation and may be called in any other name.

The first terminal-related data F1 in the first tracker terminal A1 is stored in the first storage unit 114 of the first tracker terminal A1 and managed.

The first terminal-related data F1 includes information concerning an upload hour G1, information concerning a positioned location G2, information concerning a positioned location time G3, information concerning a sensor measurement result G4, and information concerning a communication attribute G5 in association with one another.

The information concerning the upload hour G1 includes time information indicating an hour when upload is executed.

The information concerning the positioned location G2 includes information concerning a location positioned for the first tracker terminal A1.

The information of the positioned location time G3 includes time information representing an hour when the location of the measured location G2 is positioned.

The information concerning the sensor measurement result G4 includes information concerning a measurement result obtained by the first measurement unit 112.

The information concerning the communication attribute G5 includes information concerning an attribute concerning communication and includes, for example, information such as success in communication, failure in communication, or cancellation of communication as information concerning a communication result.

In the present embodiment, the first tracker terminal A1 transmits a communication signal including information concerning a location to the server 11 to upload the information to the server 11.

Here, the communication signal may include, for example, the information concerning the positioned location G2 as information concerning a location and may include the information concerning the positioned location time G3.

For example, when the communication signal includes information concerning a location at the time when upload communication failed in the past, the communication signal includes information concerning the communication attribute G5 indicating that the communication failed.

For example, when the communication information includes information concerning a location at the time when upload was canceled in the past, the communication information includes information concerning the communication attribute G5 indicating that the upload was canceled.

The communication signal may or may not include, for example, the information concerning the sensor measurement result G4.

That is, in the present embodiment, it is not essential to upload the information concerning the sensor measurement result G4 from the tracker terminal to the server 11. However, the information explained above may be uploaded and used by the server 11.

In the present embodiment, it is assumed that the communication signal includes at least the information concerning the positioned location G2 and the information concerning the positioned location time G3.

In the present embodiment, it is assumed that the communication signal includes the information concerning communication attribute G5 according to necessity.

In the present embodiment, the communication signal may not always include the information concerning the sensor measurement result G4 but may include the information concerning the sensor measurement result G4, for example, each time or when a predetermined condition is satisfied.

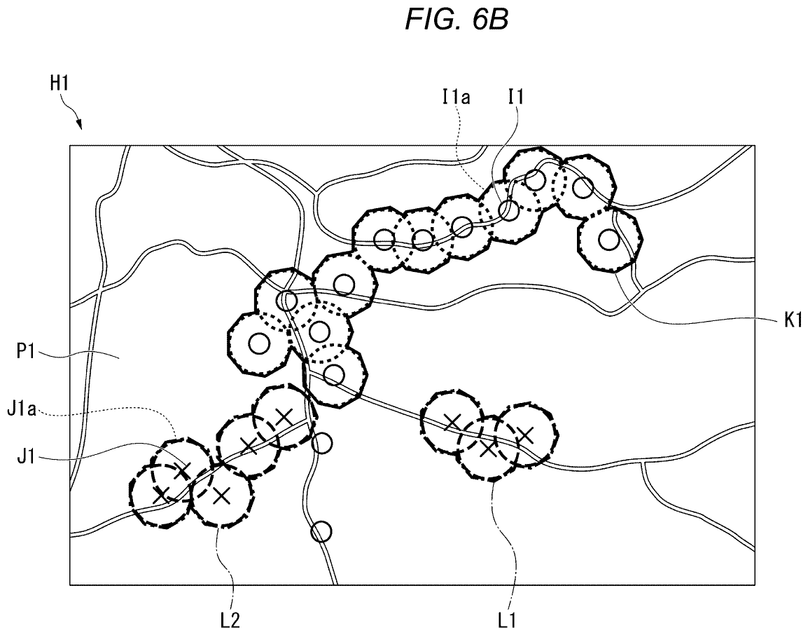

FIG. 6A is a diagram schematically illustrating an example of circular region setting for setting communication area information including a communicable area and an incommunicable area according to the embodiment.

FIG. 6A illustrates, as circular region setting information H0, a state of the circular region setting explained above.

FIG. 6A also illustrates information concerning a first map P1.

FIG. 6B is a diagram schematically illustrating an example of communication area information including a communicable area and an incommunicable area using a polygonal zone according to the embodiment.

FIG. 6B illustrates, as first communication area information H1, the communication area information explained above.

The first communication area information H1 includes information concerning the first map P1 and includes a first communicable area K1, a first incommunicable area L1, and a second incommunicable area L2 on the map.

The information concerning the first map P1 includes information concerning, for example, roads and buildings.

In the example illustrated in FIG. 6A, for each communicable location, a circular region having a predetermined radius centering on the communicable location is set.

In the example illustrated in FIG. 6A, for each incommunicable location, a circular region having a predetermined radius centering on the incommunicable location is set.

The first communicable area K1 is estimated based on three or more communicable locations.

The first incommunicable area L1 and the second incommunicable area L2 are respectively estimated based on three or more incommunicable locations.

Instead of the estimation, this may be referred to as presumption or the like.

In the present embodiment, information concerning less than three communicable locations is regarded as insufficient, and a communicable area or an incommunicable area is not set. However, as another example, even with the information concerning less than three communicable locations, a communicable or an incommunicable area may be set based on the information.

Here, in the present embodiment, a plurality of communicable locations can be acquired. However, in the examples illustrated in FIGS. 6A and 6B, in order to simplify illustration, only a first communicable location I1, which is one communicable location, is denoted by a reference sign. In the present embodiment, a circular region is set for each communicable location. However, in the examples illustrated in FIGS. 6A and 6B, in order to simplify illustration, only a first communicable circular region Ila, which is a circular region set for the first communicable location I1, is denoted by a reference sign.

In the present embodiment, a plurality of incommunicable locations can be acquired. However, in the examples illustrated in FIGS. 6A and 6B, in order to simplify illustration, only a first incommunicable location J1, which is one incommunicable location, is denoted by a reference sign. In the present embodiment, a circular region is set for each incommunicable location. However, in the examples illustrated in FIGS. 6A and 6B, in order to simplify illustration, only a first incommunicable circular region J1a, which is a circular region set for the first incommunicable location J1, is denoted by a reference sign.

In the examples illustrated in FIGS. 6A and 6B, a communicable location is indicated by a circle mark and an incommunicable location is indicated by a cross mark.

In the present embodiment, for example, the location of the first tracker terminal A1 at the time when upload communication is successful by the first tracker terminal A1 is used as the communicable location.

In the present embodiment, for example, the location of the first tracker terminal A1 at the time when upload communication is unsuccessful by the first tracker terminal A1 is used as the incommunicable location.

As the communicable location or the incommunicable location, a location satisfying another condition may be used.

In the example illustrated in FIG. 6B, communication areas such as the first communicable area K1, the first incommunicable area L1, and the second incommunicable area L2 are configured as polygonal zones.

When, in a predetermined range centering on a communicable location, another communicable location or a predetermined range centering on the other communicable location is present and, in a predetermined range centering on the other communicable location, other than the communicable location or the predetermined range centering on the communicable location, a communicable location or a predetermined range centering on the communicable location is present, the first communicable area K1 is set as a polygonal zone to extend along the outer peripheries of the predetermined ranges centering on the communicable locations. That is, for example, when a predetermined range of each of three or more communicable locations is set, in the case in which each predetermined range has an overlapping portion with at least another one communicable location or a predetermined range of the communicable location in these three or more predetermined ranges, a communicable area extending along the outer peripheries of the three or more predetermined ranges is set.

Here, in the present embodiment, the predetermined range explained above may be a circular region and may be, for example, a range having a radius of 500 m.

Although the polygonal zone is set to extend along the outer peripheries of the predetermined ranges centering on the communicable locations, the polygonal zone is not limited thereto and may be a zone that roughly surrounds the predetermined range. In this case, it is preferable to form a zone such that an incommunicable location is not included in a zone to be set.

FIG. 6C is a diagram schematically illustrating another example of the communication area information including the communicable area and the incommunicable area using the polygonal zone according to the embodiment.

FIG. 6C illustrates, as 1a-th communication area information Hla, the communication area information explained above.

A 1a-th communicable area Kla is equivalent to a zone that roughly surrounds a predetermined range.

Here, the first incommunicable area L1 and the second incommunicable area L2 illustrated in FIG. 6B are set in the same manner as the first communicable area K1.

The 1a-th incommunicable area L1a and a 2a-th incommunicable area L2a illustrated in FIG. 6C are set in the same manner as the 1a-th communicable area Kla.

FIG. 6D is a diagram schematically illustrating an example of communication area information including a communicable area and an incommunicable area using a circular zone according to the embodiment.

FIG. 6D illustrates, as second communication area information H2, the communication area information explained above.

The second communication area information H2 includes information concerning a second map P2 and includes an eleventh communicable area K11, a twelfth communicable area K12, an eleventh incommunicable area L11, and a twelfth incommunicable area L12 on the map.

The information concerning the second map P2 includes information concerning, for example, roads and buildings.

The eleventh communicable area K11 and the twelfth communicable area K12 are estimated based on three or more communicable locations.

The eleventh incommunicable area L11 and the twelfth incommunicable area L12 are respectively estimated based on three or more incommunicable locations.

Instead of the estimation, this may be referred to as presumption or the like.

In the present embodiment, information concerning less than three communicable locations is regarded as insufficient, and a communicable area or an incommunicable area is not set. However, as another example, even with the information concerning less than three communicable locations, a communicable area or an incommunicable area may be set based on the information.

Here, in the present embodiment, a plurality of communicable locations can be acquired. However, in the example illustrated in FIG. 6D, in order to simplify illustration, only an eleventh communicable location I11, which is one communicable location, is denoted by a reference sign. In the present embodiment, a circular region is set for each communicable location as in the example illustrated in FIG. 6A. However, in the example illustrated in FIG. 6D, in order to simplify illustration, only an eleventh communicable circular region Illa, which is a circular region set for the eleventh communicable location I11, is denoted by a reference sign.

In the present embodiment, a plurality of incommunicable locations can be acquired. However, in the example illustrated in FIG. 6D, in order to simplify illustration, only an eleventh incommunicable location J11, which is one incommunicable location, is denoted by a reference sign. Further, in the present embodiment, a circular region is set for each incommunicable location as in the example illustrated in FIG. 6A. However, in the example illustrated in FIG. 6D, in order to simplify illustration, only an eleventh incommunicable circular region J11a, which is a circular region set for the eleventh incommunicable location J11, is denoted by a reference sign.

In the example illustrated in FIG. 6D, an communicable location is indicated by a circle mark and an incommunicable location is indicated by a cross mark.

In the present embodiment, for example, the location of the first tracker terminal A1 at the time when upload communication is successful by the first tracker terminal A1 is used as the communicable location.

In the present embodiment, for example, the location of the first tracker terminal A1 at the time when upload communication is unsuccessful by the first tracker terminal A1 is used as the incommunicable location.

As the communicable location or the incommunicable location, a location satisfying another condition may be used.

In the example illustrated in FIG. 6D, communication areas such as the eleventh communicable area K11, the twelfth communicable area K12, the eleventh incommunicable area L11, and the twelfth incommunicable area L12 are configured as circular zones.

When, in a predetermined range centering on a communicable location, another communicable location or a predetermined range centering on the other communicable location is present and, in a predetermined range centering on the other communicable location, other than the communicable location or the predetermined range centering on the communicable location, a communicable location or a predetermined range centering on the communicable location is present, the eleventh communicable area K11 is set as a zone as a circle centering on the determined communicable location. That is, for example, when a predetermined range of each of three or more communicable locations is set, in the case in which each predetermined range has an overlapping portion with at least another one communicable location or a predetermined range of the communicable location in these three or more predetermined ranges, a communicable area is set.

Here, in the present embodiment, the predetermined range explained above may be a circular region and may be, for example, a range having a radius of 500 m.

The communicable location serving as the center is set based on, for example, coordinates of the communicable locations. The coordinates may be represented by longitude and latitude. In the example illustrated in FIG. 6D, the server 11 sets a circular zone centering on the eleventh communicable location I11. The circular zone set as explained above is set not to include an incommunicable location and a zone based on the incommunicable location. In the example illustrated in FIG. 6D, there is a portion overlapping the eleventh communicable area K11 and the twelfth communicable area K12. However, the size of the circle may be set not to overlap the eleventh communicable area K11 and the twelfth communicable area K12.

The twelfth communicable area K12 is set in the same manner as the eleventh communicable area K11.

In addition, circular zones are set in the eleventh incommunicable area L11 and the twelfth incommunicable area L12 as in the eleventh communicable area K11. The circular zone set in this way is set not to include a communicable location and a zone based on the communicable location.

As in the examples illustrated in FIGS. 6A to 6D, the server 11 performs one or both of processing for estimating, as a communicable area, a range where communication success is concentrated to some extent among information of a communication result collected from the first tracker terminal A1 and processing for estimating, as an incommunicable area, a range where communication failure is concentrated to some extent among the information of the communication result collected from the first tracker terminal A1. Then, the server 11 generates communication area information using a polygonal zone, a circular zone, or the like based on the estimation result explained above.

Here, the communication area estimation processing explained above may be performed by, for example, the area processing unit 353 of the server 11.

For example, the server 11 may perform reevaluation on the once generated communication area information at periodic timing, timing at a point in time when information concerning a communication result is added to some extent, or the like and update the communication area information according to necessity.

For example, the server 11 may handle new information with a larger weight based on the newness of the information concerning the communication result to preferentially reflect new information close to the present on the communication area information.

Here, the communication area update processing explained above may be performed by, for example, the area processing unit 353 of the server 11.

In the present embodiment, a communicable area and an incommunicable area are explained as a specific area. However, for example, only any one of the communicable area and the incommunicable area may be used.

For example, in a configuration in which upload communication is attempted using only the communicable area when the second tracker terminal A2 is present in the communicable area, unnecessary communication can be securely suppressed and power consumption in the second tracker terminal A2 can be reduced. In contrast, in a configuration in which upload communication is attempted using only the incommunicable area when the second tracker terminal A2 is present on the outer side of the incommunicable area, failure in data communication can be more likely but a time lag of the data communication can be reduced.

In general, the quality of communication depends on an installation situation of a base station, a situation of an obstacle such as a building, a situation of a terrain such as a flat ground or a mountain, and the like in a region that is an evaluation target.

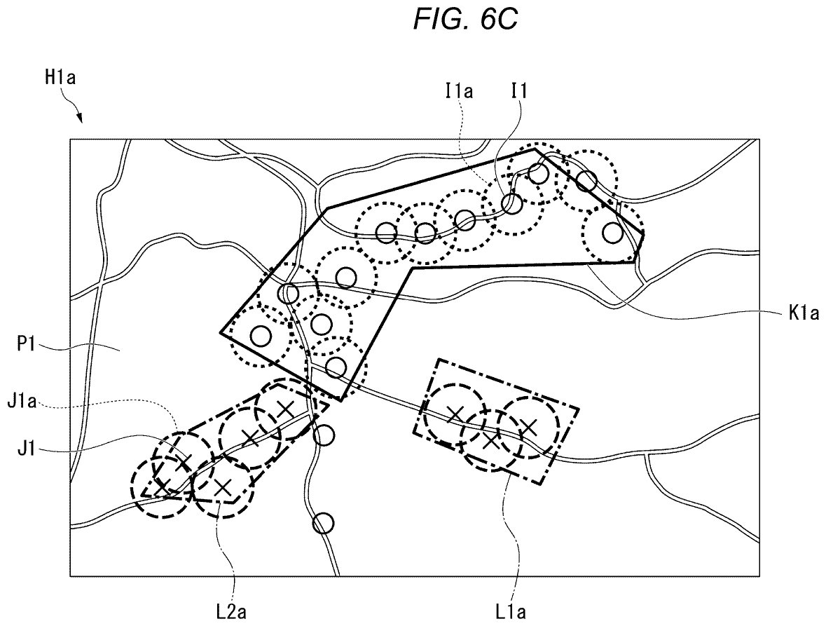

FIG. 7 is a diagram illustrating an example of a flow of processing at the time of upload from the first tracker terminal A1 to the server 11 according to the embodiment.

FIG. 7 illustrates the first tracker terminal A1 and the server 11.

In the first tracker terminal A1, a first communication module R1 having the function of the first wireless communication unit 113 is illustrated.

FIG. 7 illustrates the first location information C1, the first measurement information C2, and the first area information C4 in the first tracker terminal A1.

FIG. 7 illustrates the terminal information E1 and the area information E2 in the server 11.

In the example illustrated in FIG. 7, information concerning the sensor measurement result G4 is also uploaded.

In the example illustrated in FIG. 7, as processing performed by the first tracker terminal A1, processing T1 to processing T4 and processing T11 and processing T12 are illustrated.

In the example illustrated in FIG. 7, as processing performed by the server 11, processing T21 to processing T23 are illustrated.

In the processing T1, the first tracker terminal A1 acquires the location and the like with GNSS or the like. In the present embodiment, in the first tracker terminal A1, the first location information acquisition unit 111 acquires first location information and the first measurement unit 112 acquires first measurement result information.

The first tracker terminal A1 stores the acquired first location information and the acquired first measurement information.

In the processing T2, the first tracker terminal A1 refers to the latest location of the first tracker terminal A1 and the first area information C4 to determine whether communication can be executed.

The latest location may be, for example, the current location of the first tracker terminal A1.

In the processing T3, when a result of the determination as to whether communication can be executed indicates that communication is possible, the first tracker terminal A1 uploads the first location information and the first measurement information stored in the first tracker terminal A1 to the server 11.

In this case, the processing T11 and the processing T12 are performed.

On the other hand, in the processing T4, when the result of the determination as to whether communication can be executed indicates that communication is impossible, the first tracker terminal A1 gives upload impossible to the communication attribute G5 of the e first location information and the first measurement information of this time.

In the processing T11, the first tracker terminal A1 performs communication connection to the base station.

The base station may be any base station capable of communicating with the first tracker terminal A1.

In the processing T12, the first tracker terminal A1 uploads upload target data to the server 11 via the base station.

In the processing T21, the server 11 registers the terminal information E1 based on the uploaded data in a predetermined database.

In the processing T22, the server 11 adds a communication result to the area information E2 from the communication data with the first tracker terminal A1 and the first location information. Here, the communication data is, for example, data from which the possibility of communication or communication intensity can be grasped.

In the processing T23, the server 11 estimates a communication area from a communication result to that point and sets or updates a communication area for the area information E2 based on a result of the estimation.

In the processing T21 explained above, the server 11 registers the location information received from the first tracker terminal A1 in the terminal information E1.

At this time, for example, only when determining that an hour of the positioned location time G3 of the first location information uploaded from the first tracker terminal A1 and the present hour are close, the server 11 may adopt the first location information as the terminal information E1 assuming that the first location information is location information at the time when communication is successful.

In the processing T22 explained above, the server 11 may register, in the area information E2, a communicable location based on the location information at the time when the communication is successful.

The determination as to whether the hour of the positioned location time G3 of the first location information and the preset hour is close may be performed by, for example, the determination unit 352.

As an example, when the difference between the hour and the present hour is less than a predetermined time, the determination unit 352 may determine that the hour and the present hour are close. Otherwise, the determination unit 352 may determine that the hour and the present hour are far.

The server 11 may perform the registration in the area information E2 based on the information concerning the communication attribute G5 included in a communication signal uploaded from the first tracker terminal A1.

As an example, when the communication attribute G5 indicates a communication failure, the server 11 may register, in the area information E2, an incommunicable location based on location information corresponding to the communication attribute G5. That is, the server 11 may register, in the area information E2, an incommunicable location based on location information at the time when communication is unsuccessful.

As another example, when the communication attribute G5 indicates communication cancellation, the server 11 may register, in the area information E2, reference information based on location information corresponding to the communication attribute G5. That is, the server 11 may register, in the area information E2, reference information based on location information at the time when the communication is canceled. The reference information may be used in any form or may not be used in the server 11.

In the processing T23 explained above, when determining that a specific area can be estimated based on the communicable location and the incommunicable location registered in the area information E2, the server 11 generates communication area information including the specific area.

Here, the specific area is, for example, a communicable area or an incommunicable area.

As a method of estimating a communicable area or a method of estimating an incommunicable area, any method may be used.

For example, when determining that location information uploaded from the first tracker terminal A1 coincides with the location on the inside of an already present communicable area or incommunicable area, the server 11 may review the relevant communicable area or the relevant incommunicable area according to data content relating to the upload and, as a result, may change or delete the communicable area or incommunicable area according to necessity.

Note that, here, the server 11 estimates a communicable area or an incommunicable area based on a communicable location and an incommunicable location. However, as another example, the server 11 may estimate a communicable area or an incommunicable area based on first location information and information concerning communication intensity at the location instead of the communicable location and the incommunicable location.

As an example, when the communication intensity is equal to or larger than a predetermined value, the server 11 may determine that communication is possible and set the location as the communicable location and, when the communication intensity is smaller than the predetermined value, the server 11 may determine that communication is impossible and set the location as the incommunicable location.

As another example, the server 11 may collect communication intensity at each of a plurality of locations and estimate a communicable area or an incommunicable area based on the tendency of the communication intensity at the plurality of locations.

The information concerning the communication intensity notified from the first tracker terminal A1 to the server 11 may be, for example, information indicating the communication intensity itself or may be information representing a result of determining a magnitude relation between the communication intensity and the predetermined threshold. That is, the determination concerning the communication intensity may be performed by, for example, the server 11, may be performed by the first tracker terminal A1, or may be performed by both of the server 11 and the first tracker terminal A1.

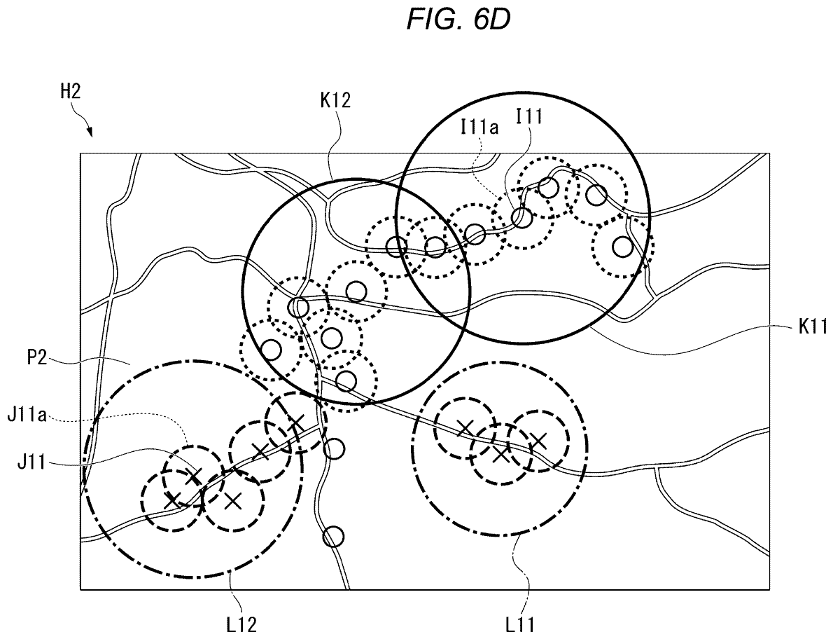

FIG. 8 is a diagram illustrating an example of a flow of processing at the time when the second tracker terminal A2 according the to embodiment acquires communication area information from the server 11.

FIG. 8 illustrates the second tracker terminal A2 and the server 11.

In the second tracker terminal A2, a second communication module R2 having a function of the second wireless communication unit 213 is illustrated.

FIG. 8 illustrates the second area information D4 in the second tracker terminal A2.

FIG. 8 illustrates the area information E2 in the server 11.

In the example illustrated in FIG. 8, as processing performed by the second tracker terminal A2, processing T101 and processing T102 and processing T111 and processing T112 are illustrated.

In the example illustrated in FIG. 8, as processing performed by the server 11, processing T121 is illustrated.

In the processing T101, the second tracker terminal A2 performs update determination for an elapsed time or the like based on the second area information D4 retained by the second tracker terminal A2.

Here, in the update determination for the elapsed time or the like, processing for determining, based on an elapsed time or the like of the specific area included in the second area information D4, whether to update the second area information D4 is performed.

As an example, when the elapsed time of the second area information D4 exceeds a predetermined value, the second tracker terminal A2 may determine to update the second area information D4.

In the processing T102, when updating the second area information D4, the second tracker terminal A2 performs processing for acquiring communication area information from the server 11.

In this case, the processing T111 and the processing T112 are performed.

In the processing T111, the second tracker terminal A2 performs communication connection to the base station.

The base station may be any base station capable of communicating with the second tracker terminal A2.

In the processing T112, the second tracker terminal A2 transmits a request for communication area information to the server 11 via the base station and, after the processing T121, receives a response to the request from the server 11. The response includes communication area information transmitted from the server 11.

In the processing T121, in response to the request for communication area information received from the second tracker terminal A2, the server 11 transmits the latest communication area information to the second tracker terminal A2.

As the latest communication area information, for example, information stored in the area information E2 may be used.

The second tracker terminal A2 may acquire a current location with the second location information acquisition unit 211 at regular timing or at any timing such as when movement of a tracking target is detected by an IMU or the like. The second tracker terminal A2 stores the acquired location information in an internal storage as second location information.

The regular timing may be any timing and may be, for example, timing of every 10 minutes.

The second tracker terminal A2 determines whether to perform upload communication at the current location based on a communicable area or an incommunicable area based on the second area information D4 stored on the inside and the location of the acquired second location information.

When determining based on the second area information D4 that upload communication is possible, the second tracker terminal A2 switches a power supply of a wireless communication device configuring the second wireless communication unit 213 from off to on and starts the upload communication. When the communication is successful, the second tracker terminal A2 may delete transmitted data from the internal storage.

On the other hand, when the communication is unsuccessful, the second tracker terminal A2 updates the second terminal-related data F2 in the internal storage to give the communication attribute G5 of “communication failure” to the positioned location G2 equivalent to the location acquired this time.

When the second tracker terminal A2 determines that upload communication is not possible based on the second area information D4, and thus determines to cancel the communication, the second tracker terminal A2 updates the second terminal-related data F2 in the internal storage as to assign the communication attribute G5 of “communication cancel” to the positioned location G2 corresponding to the location acquired this time.

The second terminal-related data F2 is the same data as the first terminal-related data F1 illustrated in FIG. 5.

In the present embodiment, the second tracker terminal A2 turns off the power supply of the second wireless communication unit 213 when the upload communication is not performed, switches the power supply of the second wireless communication unit 213 to on when the upload communication is performed, and switches the power supply to off again when the communication is completed. Accordingly, in the second tracker terminal A2, electric power consumed by the second wireless communication unit 213 can be reduced.

Instead of an aspect in which the power supply of the second wireless communication unit 213 is turned off, an aspect in which the power supply of the second wireless communication unit 213 is set to a low power consumption state between off and on may be used.

Various kinds of timing may be used as the timing when the second tracker terminal A2 updates the second area information D4.

For example, the second tracker terminal A2 may request communication area information from the server 11 at any timing such as after succeeding in the upload communication, receive a response message to the request from the server 11, and update the second area information D4. The response message includes communication area information provided from the server 11. The second tracker terminal A2 stores the acquired communication area information in the internal storage.

The communication area information, for example, set, updated, or deleted by the server 11, the communication area information transmitted from the server 11 to the second tracker terminal A2, and the communication area information, for example, set, updated, or deleted in the second tracker terminal A2 may be respectively, for example, inseparable information or information including a plurality of elements.

When the communication area information including the plurality of elements is used, for example, the communication area information may be, for example, set, updated, or deleted for each of the elements. The element may be, for example, one each communicable area or one each incommunicable area.

That is, when the communication area information includes a plurality of individual communication areas including a communicable area or an incommunicable area, for example, the communication area information may be, for example, set, updated, or deleted for each of the individual communication areas.

Note that a term “individual communication area” is for convenience of explanation and may be called in any other name.

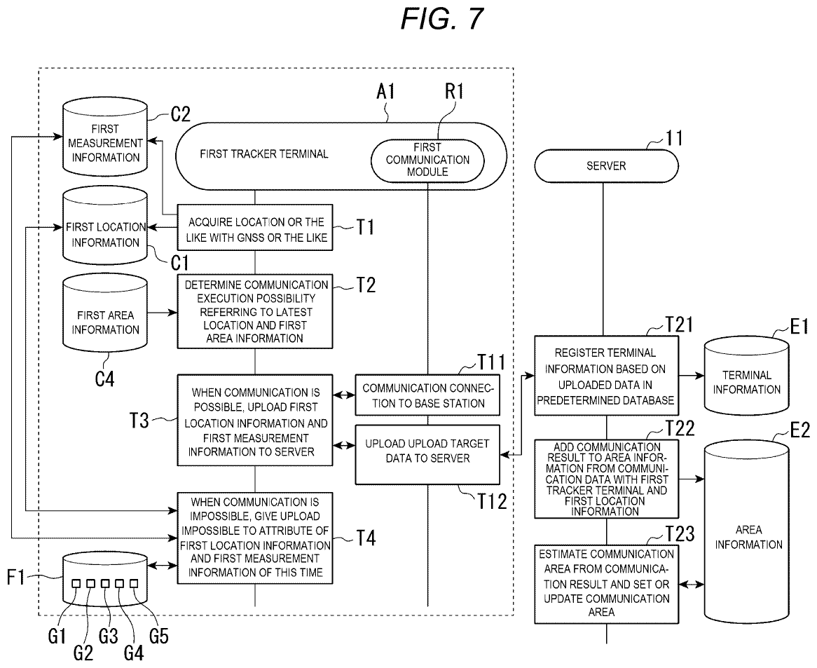

FIG. 9 is a diagram illustrating an example of delivery bases and directions among the bases according to the embodiment.

FIG. 9 illustrates a first base U1, a second base U2, a third base U3, and a fourth base U4, which are delivery bases, on a predetermined map.

In this example, as an example, the first base U1 is a departure point of a delivery vehicle 611 mounted with the second tracker terminal A2.

In this example, the second base U2 is a base for a delivery destination of the delivery vehicle 611.

On the other hand, in this example, the third base U3 and the fourth base U4 are not bases for delivery destinations of the delivery vehicle 611.

In this case, for example, communication area information needs to be set for a region corresponding to a first direction Dr1 from the first base U1 toward the second base U2.

On the other hand, in this case, for example, communication area information may not be set for a region corresponding to a second direction Dr2 from the first base U1 toward the third base U3 and a region corresponding to a third direction Dr3 from the first base U1 toward the fourth base U4.

In this example, there is one base for a delivery destination of the delivery vehicle 611. However, for example, when there are a plurality of bases for delivery destinations of the delivery vehicle 611, communication area information corresponding to all regions of the plurality of bases may be set.

Here, in the example illustrated in FIG. 9, a Japan map is schematically illustrated.

In this case, for example, a unit of a region such as a prefecture or a municipality may be used as a unit region of a communication area.

As a unit of a delivery base as well, for example, a unit of a region such as a prefecture or a municipality may be used.

Note that the unit of the region explained above is an example and is not always limited thereto.

In the example illustrated in FIG. 9, a communicable area or an incommunicable area can be notified from the server 11 to the second tracker terminal A2 in a necessary and sufficient range according to a moving direction of the second tracker terminal A2 based on a delivery base. Accordingly, for example, it is possible to omit processing for setting, in the second tracker terminal A2, communication area information not used by and unnecessary for the second tracker terminal A2. It is possible to reduce a load imposed on a processor and a memory in the second tracker terminal A2.

In the server 11, as an example, a communication area where the second tracker terminal A2 needs to receive a notification or a communication area where the second tracker terminal A2 does not need to receive a notification may be determined based on delivery information concerning delivery allocated to the delivery vehicle 611 mounted with the second tracker terminal A2.

In this case, the server 11 stores delivery information corresponding to the second tracker terminal A2 as a part of the terminal information E1. For example, the delivery information may be notified from the second tracker terminal A2 or the like to the server 11 by upload or may be set in the server 11 by a not-illustrated user or a not-illustrated external device.

The delivery information may include, for example, information concerning a delivery base serving as a delivery destination of delivery performed by the delivery vehicle 611 mounted with the second tracker terminal A2 and may further include information concerning a delivery base serving as a departure point of the delivery.

Schematically, for an is area where it determined by the server 11 that the second tracker terminal A2 passes in order to move to the delivery destination, a communicable area or an incommunicable area is set for the second tracker terminal A2. On the other hand, for an area where it is determined by the server 11 that the second tracker terminal A2 does not pass when moving to a delivery destination, a communicable area or an incommunicable area is not set for the second tracker terminal A2.

In this example, delivery information of the delivery vehicle 611 mounted with the second tracker terminal A2 is used as delivery information of the second tracker terminal A2.

Delivery management information including the delivery information is managed by, for example, the terminal information E1 of the server 11.

The delivery management information may include, for example, identification information of the delivery vehicle 611 mounted with the second tracker terminal A2, identification information of the second tracker terminal A2 attached to the delivery vehicle 611, delivery information for each delivery vehicle 611, and information concerning a current location of the delivery vehicle 611. As the current location, a current location of the second tracker terminal A2 is used.

In the present embodiment, the identification information of the delivery the vehicle 611 and identification information of the second tracker terminal A2 mounted on the delivery vehicle 611 are linked. For example, as the identification information of the second tracker terminal A2, identification information of equipment such as a sensor provided in the second tracker terminal A2 may be used.

In the present embodiment, the delivery information includes, for example, information concerning a date when delivery is performed and information for specifying a delivery base serving as a delivery destination, such as information indicating that “to be delivered to which base on YY month, XX day”.

When the server 11 is configured to grasp the current location of the delivery vehicle 611, for an area present between the current location of the delivery vehicle 611 mounted with the second tracker terminal A2 and a delivery base serving as a delivery destination, the server 11 may extract, based on the delivery management information, communication area information including a communicable area or an incommunicable area from a database and transmit the extracted communication area information to the second tracker terminal A2.

For example, the server 11 extracts an area including a route set in advance in order to head from the first base U1 of the departure point to the second base U2 of the delivery destination as the area present between the current location of the delivery vehicle 611 and the delivery base serving as the delivery destination. Here, the route set in advance may be a route set by a car navigation system of the delivery vehicle 611 or may be a route instructed by a company to which a driver who drives the delivery vehicle 611 belongs.

The server 11 connects the first base U1 of the departure point and the second base U2 of the delivery destination with a straight line and extracts an area included in a range of 100 km centering on the connecting straight line as the area present between the current location and the delivery base serving as the delivery destination. Here, the range of 100 km is exemplified but the range is not limited thereto. For example, the range may be a range of 50 km shorter than the range of 100 km. By setting the range to 50 km, the communication area information retained by the second tracker terminal A2 can be reduced.

For example, when the straight line is a straight line in the longitudinal direction, the range of 100 km centering on the straight line is a range up to 100 km to the left side and up to 100 km to the right side with respect to the straight line and is a range up to a place shifted to the upper side by 100 km and up to a place shifted to the lower side by 100 km.

In this case, for example, it is possible to further reduce the communication area information retained by the second tracker terminal A2 compared with a case in which communication area information of all areas from the delivery base serving as the departure point to the delivery base serving as the delivery destination is set in the second tracker terminal A2.

In the above explanation, the delivery information of the second tracker terminal A2 is grasped in advance and the action range of the second tracker terminal A2 is grasped in advance. However, as another example, the action range of the second tracker terminal A2 may be estimated by the server 11.

As the other example explained above, a configuration may be used in which the server 11 estimates and determines action range information, which is information concerning the action range of the second tracker terminal A2, as an area where the second tracker terminal A2 needs to receive a notification.

The action range information may directly include, for example, information concerning a location uploaded from the second tracker terminal A2 or include information based on the location.

The information based on the location may be, for example, information concerning a result obtained by determining the action range of the second tracker terminal A2 based on a change in the location of the second tracker terminal A2. This determination may be, for example, presumptive determination.

For example, the server 11 may determine the action range of the second tracker terminal A2 based on the change in the location of the second tracker terminal A2, extract communication area information including a communicable area or an incommunicable area suitable for the determined action range from the database, and transmit the extracted communication area information to the second tracker terminal A2.

Here, the communication area information including the communicable area or the incommunicable area suitable for the determined action range may be, for example, communication area information including a communicable area or an incommunicable area present in the determined action range.

As a specific example, the server 11 may first transmit communication area information of a wide range to the second tracker terminal A2, thereafter determine an action range of the second tracker terminal A2, and transmit the communication area information narrowed down to the determined action range to the second tracker terminal A2.

For example, the server 11 determines that an area of communication area information actually used by the second tracker terminal A2 to control communication is the action range of the second tracker terminal A2 and determines that an area of communication area information not used by the second tracker terminal A2 to control communication is outside the action range of the second tracker terminal A2. In this case, for example, the second tracker terminal A2 transmits and notifies, to the server 11, the communication area information used to control communication and the communication area information not used to control communication.

Accordingly, in the server 11, since the action range of the second tracker terminal A2 is specified as a narrower range as time elapses, the communication area information set in the second tracker terminal A2 gradually changes from the range set first to a narrowed range and gradually approaches only a necessary range, which is efficient.

In the case explained above, the server 11 can notify not communication area information concerning all areas present in the database but narrow down the communication area information to communication area information concerning an area present on the inside of an action range estimated from location information uploaded from the second tracker terminal A2 and notify the communication area information as a response to the second tracker terminal A2. The second tracker terminal A2 acquires and uses the communication area information, the range of which is narrowed as explained above.

In this case, it is possible to reduce an amount of data of communication performed between the server 11 and the second tracker terminal A2.

As explained above, in the example illustrated in FIG. 9, for example, the server 11 may first set the communication area information of the range throughout Japan in the second tracker terminal A2 and thereafter narrow the range based on the delivery management information set at any timing or the action range information obtained by estimation.

Note that, for example, the action range of the second tracker terminal A2 can be more securely specified when delivery management information indicating an actual delivery situation is used than when the action range information obtained by the estimation is used.

In the present embodiment, in the server 11, the processing concerning the action range is performed by the action range processing unit 354.

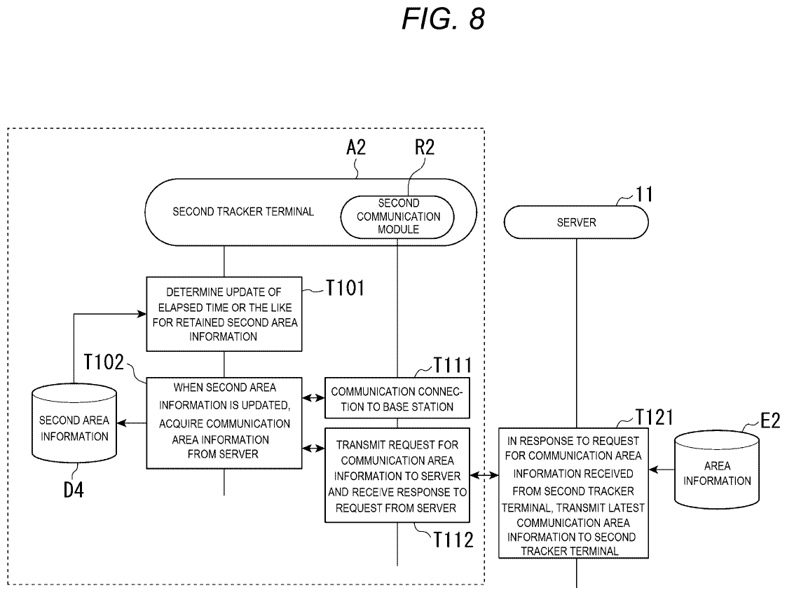

FIG. 10 is a diagram illustrating an example of a first table Ta1 that associates an action history of a tracker terminal and a notification range of a communication area according to the embodiment.

The first table Ta1 stores terminal identification information, an action history, and notification range of a communication area in association with each one another.

Information of the first table Ta1 may be stored as a part of the terminal information E1, for example, in the server 11.

The terminal identification information is information for identifying each of the first tracker terminal A1 to the N-th tracker terminal AN.

The action history may be a history of actions of each of the first tracker terminal A1 to the N-th tracker terminal AN and may be set based on, for example, a situation of a change in a location of each of the first tracker terminal A1 to the N-th tracker terminal AN. The situation of the change in the location of each of the first tracker terminal A1 to the N-th tracker terminal AN represents, for example, a situation of movement of each of the first tracker terminal A1 to the N-th tracker terminal AN.

The notification range of the communication area represents a range of a communication area in which communication area information should be notified to each of the first tracker terminal A1 to the N-th tracker terminal AN.

In the example illustrated in FIG. 10, a first action history is an action history in which an entire region in a predetermined map is set as an action range.

For this reason, when the action history of the second tracker terminal A2 is the first action history, for example, control for setting the communication area information of the entire region in the second tracker terminal A2 is performed.

For example, the first action history is an action history in the case in which the delivery vehicle 611 is moving between the first base U1 and the second base U2 and is moving between the first base U1 and the fourth base U4, that is, an action history in which the notification range of the communication area cannot be specified from the action history.

In the example illustrated in FIG. 10, a second action history is an action history in which a partial aa-th region in the predetermined map is set as an action range.

For this reason, when the action history of the second tracker terminal A2 is the second action history, for example, control for setting communication area information of the aa-th area in the second tracker terminal A2 is performed.

For example, the second action history is an action history in the case in which the delivery vehicle 611 is moving only between the first base U1 and the second base U2, that is, an action history in which the aa-th region can be specified as the notification range of the communication area because the delivery vehicle 611 moves only between the first base U1 and the second base U2.

In the example illustrated in FIG. 10, a third action history is an action history in which a partial bb-th region in the predetermined map is set as an action range. The bb region represents a region different from the aa region.

Therefore, when the action history of the second tracker terminal A2 is the third action history, for example, control is performed to set the communication area information of the bb-th area in the second tracker terminal A2.

For example, the third action history is an action history in the case in which the delivery vehicle 611 is moving only between first base U1 and fourth base U4, that is, an action history in which the bb-th region can be specified as the notification range of the communication area because the delivery vehicle 611 moves only between first base U1 and fourth base U4.

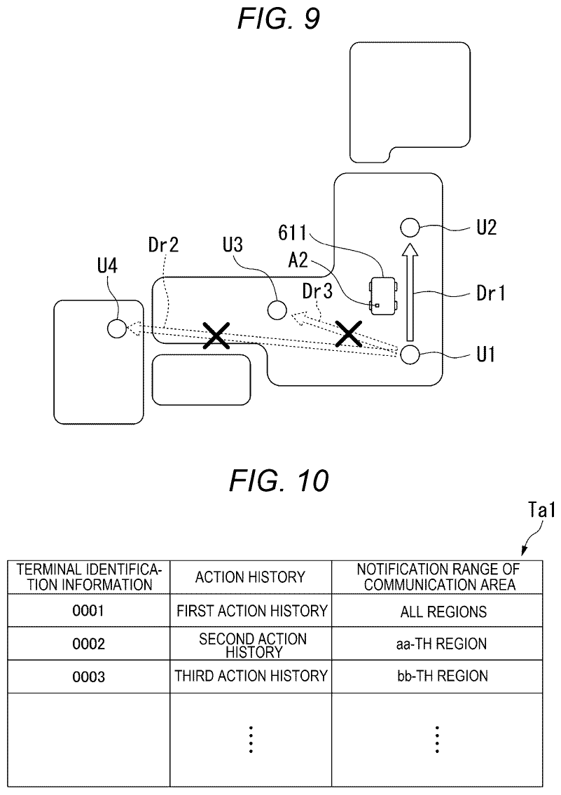

FIG. 11 is a diagram illustrating an example of a flow of processing in which the server 11 changes the notification range of the communication area according to the action history of the tracker terminal according to the embodiment.

FIG. 11 illustrates the second tracker terminal A2 and the server 11.

In the second tracker terminal A2, a second communication module R2 having a function of the second wireless communication unit 213 is illustrated.

FIG. 11 illustrates the second area information D4 in the second tracker terminal A2.

FIG. 11 illustrates the terminal information E1 and the area information E2 in the server 11.

In the example illustrated in FIG. 11, as processing performed by the second tracker terminal A2, processing T201 and processing T202 and processing T211 to processing T214 are illustrated.

In the example illustrated in FIG. 11, as processing performed by the server 11, processing T221 to processing T224 are illustrated.

In the processing T201, the second tracker terminal A2 uploads the second location information to the server 11 via the base station.

In this case, the processing T211 and the processing T212 are performed.

In the processing T211, the second tracker terminal A2 performs communication connection to the base station.

The base station may be any base station capable of communicating with the second tracker terminal A2.

In the processing T212, the second tracker terminal A2 uploads upload target data to the server 11 via the base station.

In the processing T221, the server 11 registers the terminal information E1 based on the uploaded data in a predetermined database.

In the processing T222, the server 11 acquires an action history for each tracker terminal.

In this example, the server 11 may acquire the action history based on the terminal information E1.

In the processing T223, the server 11 generates or updates the notification range of the communication area for each tracker terminal based on the acquired action history.

In the processing T202, the second tracker terminal A2 assumes that timing for updating the second area information D4 has come. In this case, the second tracker terminal A2 performs processing for acquiring communication area information from the server 11.

In this case, the processing T213 and the processing T214 are performed.

In the processing T213, the second tracker terminal A2 performs communication connection to the base station.

The base station may be any base station capable of communicating with the second tracker terminal A2.

In the processing T214, the second tracker terminal A2 transmits a request for communication area information to the server 11 via the base station and receives a response to the request from the server 11 after the processing T224. The response includes communication area information received from the server 11.

In the processing T224, in response to the request for communication area information received from the second tracker terminal A2, the server 11 transmits the latest communication area information to the second tracker terminal A2.

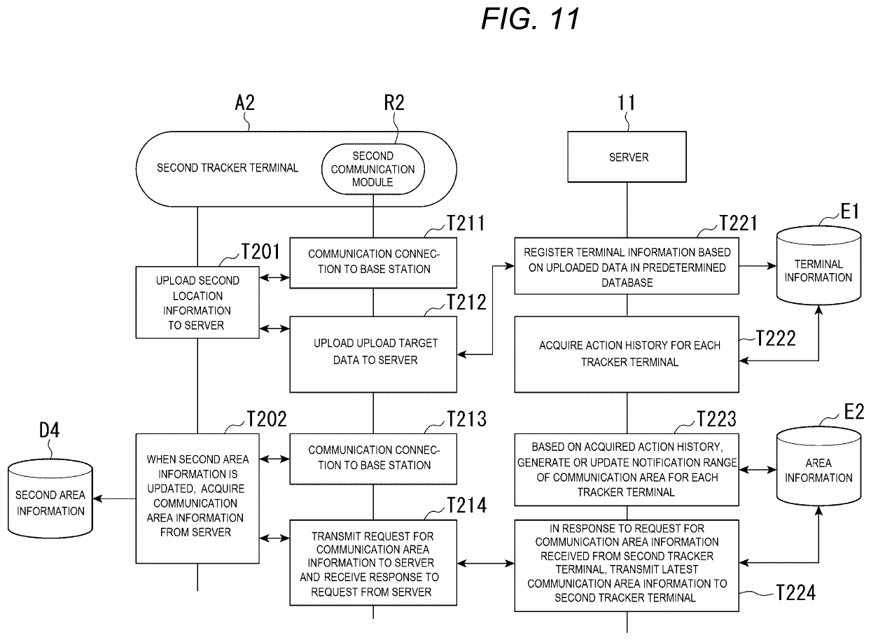

FIG. 12 is a diagram illustrating an example of a second table Ta2 that associates individual communication area identification information of the tracker terminal and a reference time according to the embodiment.

Information of the second table Ta2 may be stored as a part of the area information E2, for example, in the server 11.

The second table Ta2 stores the individual communication area identification information and the reference time in association with each other.

Here, the individual communication area identification information is information for identifying an individual communication area.

As the individual communication area, there is, for example, a communicable area or an incommunicable area. The individual communication area may include both of the communicable area and the incommunicable area. In this example, the individual communication area represents a communication area serving as a unit of new setting, update, or deletion.

As the reference time associated with the individual communication area, for example, an update date and time, which is a date and time when new setting or update was performed last time, may be used. Note that, in this example, for convenience of explanation, a case in which not the update but the new setting was performed last time is also referred to as update date and time.

As the update date and time, for example, a date and time when original data at the time when the individual communication area is generated by the server 11 was acquired by the first tracker terminal A1 may be used.

The original data may be, for example, data of communicable points or incommunicable points illustrated in FIGS. 6A to 6D.

When one individual communication area is generated based on a plurality of pieces of original data, the update date and time associated with the individual communication area may be set as, for example, a date and time of the oldest original data among the plurality of pieces of original data.

In this example, it is assumed that it is likely that a communication environment has changed according to elapse of time for an individual communication area, an update date and time of which is old exceeding a predetermined period.

For example, the update date and time of the original data of the individual communication area may be notified, for example, from the server 11 to the second tracker terminal A2. This notification may be performed, for example, when the server 11 transmits communication area information including the individual communication area to the second tracker terminal A2. In this example, the information in the second table Ta2 illustrated in FIG. 12 is stored as the second area information D4 in the second tracker terminal A2 by the notification explained above.

As another example, the information of the second table Ta2 illustrated in FIG. 12 may be stored in the server 11 and the information may be notified from the server 11 to the second tracker terminal A2 in response to a request from the second tracker terminal A2 to the server 11.

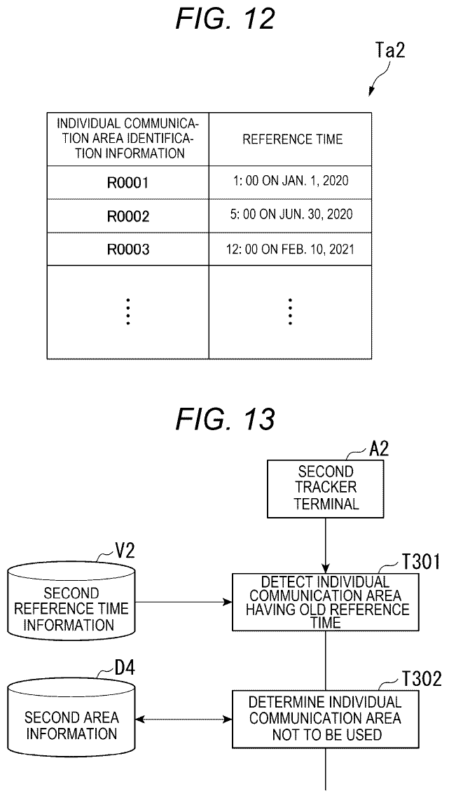

FIG. 13 is a diagram illustrating an example of a flow of processing for determining presence or absence of use of an individual communication area according to a reference time of the individual communication area in the tracker terminal according to the embodiment.

FIG. 13 illustrates the second tracker terminal A2.

FIG. 13 illustrates the second area information D4 and second reference time information V2 in the second tracker terminal A2.

Here, the second reference time information V2 includes the information of a second table Ta2 illustrated in FIG. 12.

In the example illustrated in FIG. 13, as processing performed by the second tracker terminal A2, processing T301 and processing T302 are illustrated.

In the processing T301, the second tracker terminal A2 refers to the second reference time information V2 to detect an individual communication area having an old reference time.

In this example, the second tracker terminal A2 determines that an individual communication area, an elapsed period of which from a reference time exceeds a predetermined period, is an old individual communication area and, on the other hand, determines that an individual communication area, an elapsed period of which from the reference time is less than the predetermined period, is an individual communication area that is not old.

In the processing T302, the second tracker terminal A2 determines that a part or the entire individual communication area regarded as old is an individual communication area not to be used. The individual communication area not to be used may be referred to as, for example, nonuse individual communication area.

The second tracker terminal A2 updates the second area information D4 such that the individual communication area determined not to be used is not used. Accordingly, the second tracker terminal A2 can set an old individual communication area as nonuse.

As explained above, the second tracker terminal A2 stores, for example, the date and time when the original data for setting the communication area information was acquired is stored and, when the communication area information is used, determines whether the predetermined period has elapsed from the date and time when the original data was acquired. The second tracker terminal A2 does not use communication area information for which the predetermined period has already elapsed from the date and time when the original data was acquired. In this case, for example, in order to update the communication area information set in the second tracker terminal A2 to new information, the second tracker terminal A2 may request the server 11 to notify latest the communication area information.

For example, since an installation situation of the base station can change even in the same area, it is effective to update the communication area information at timing such as every predetermined period.

Here, any period be may used as the predetermined period and, for example, a period in units of years such as one year may be used.

As another example, a date and time when individual communication area is set anew may be used as a reference time associated with the individual communication area and, further, for example, in a configuration in which the individual communication area is updated, a date and time when the individual communication area was updated last time may be used.

That is, as the reference time associated with the individual communication area, for example, a date and time concerning original data used to generate the individual communication area may be used or a date and time when the individual communication area itself was generated may be used.

In the examples illustrated in FIGS. 12 and 13, a configuration example in which the second tracker terminal A2 performs control for old communication area information not to be used is explained. However, as another example, a configuration in which the server 11 performs control for old communication area information not to be used may be used.

In this case, the server 11 updates, based on the information of the second table Ta2 illustrated in FIG. 12, the communication area information included in the area information E2 to set old individual communication area as nonuse.

As another example, the server 11 may store, for each individual communicable point or incommunicable point, as a reference time, in association with the point, a date and time when the point was set.

Then, the server 11 may perform control for setting a communicable point or an incommunicable point, an elapsed period of which from the reference time exceeds the predetermined period, as nonuse. In this case, for example, the server 11 may set, as nonuse, a communicable region or an incommunicable region set based on information including the communicable point or the incommunicable point set as nonuse, and instead, set a communicable region or an incommunicable region anew based on information excluding the communicable point or the incommunicable point set as nonuse.

In the above explanation, the first tracker terminal A1 notifies, to the server success of communication, failure of communication, or cancellation of communication for data communication for uploading. However, for example, the first tracker terminal A1 may further notify information concerning a base station to which the e first tracker terminal A1 was successfully connected at the time of the data communication.

The information concerning the base station may include, for example, identification information of the base station and may further include reception intensity of a radio wave from the base station.

The server 11 may set a communicable area or an incommunicable area based on, not only information such as success of communication, failure of communication, or cancellation of communication at locations of the first tracker terminal A1 but also, for example, identification information of the base station to which the first tracker terminal A1 was successfully connected. Further, the server 11 set the communicable area or may the incommunicable area based on not only these kinds of information at the locations of the first tracker terminal A1 but also, for example, radio wave reception intensity of the first tracker terminal A1 from the base station. With the configuration explained above, for example, the accuracy of the communicable area and the incommunicable area can be improved.

In the above explanation, a case is explained in which, when a tracker terminal performs data communication while moving, the influence of the movement is not considered. However, for example, each tracker terminal may perform processing for correcting information concerning, for example, the location of the tracker terminal according to speed, acceleration, or the like of movement of the tracker terminal using a function of the GNSS or another function. When there is no problem in accuracy in practical use, the correction explained above may not always be performed.

In the above explanation, the server 11 acquires information from a tracker terminal and generates communication area information including a communicable area or an incommunicable area based on the acquired information.

As another configuration example, the tracker terminal may have a function of generating communication area information including a communicable area or an incommunicable area based on information concerning the location and a communication situation of the tracker terminal.

The tracker terminal explained above may have a function of notifying the generated communication area information to the server 11. In this case, for example, the server 11 may directly use the communication area information received from the tracker terminal or may use the communication area information received from the tracker in order to generate or update the communication area information managed by the server 11.

For example, when a configuration in which communication area information including a communicable area or an incommunicable area is respectively generated by both of the server 11 and the tracker terminal is used, a configuration in which the communication area information generated by the server 11 and the communicable area information generated by the tracker terminal are notified to each other between the server 11 and the tracker terminal to share the communication area information retained by the server 11 and the tracker terminal may be used.

As an example, comprehensive communication area information in which the communication area information of the server 11 and the communication area information of the tracker terminal are complemented with each other may be generated. The generation of the comprehensive communication area information may be performed by, for example, the server 11.

As explained above, in the information processing system 1 according to the present embodiment, the communication area information is generated and managed by the server 11 based on the information acquired by the first tracker terminal A1 and the server 11 uses the communication area information and does not cause the second tracker terminal A2 to perform upload communication in an area where communication is highly likely to be unsuccessful.

In the information processing system 1 according to the present embodiment, by suppressing such communication, it is possible to reduce wasteful communication highly likely to be unsuccessful and it is possible to reduce power consumption in the second tracker terminal A2.

As a specific example, in the information processing system 1 that manages the location of a distribution truck or the like, it is possible to set, based on communication information linked with location information transmitted from the first tracker terminal A1 attached to a first truck, an area where the second tracker terminal A2 attached to a second truck does not communicate with the server 11.

For example, in an operation of a tracker terminal of a tracking service for the purpose of grasping a location or a route concerning a distributed material, a distributed cargo, a person, or the like, the tracker terminal being able to operate for a long period with built-in power such as a battery or a cell is likely to expand a use range of the tracker terminal, a maintenance-free period can be extended, and convenience is improved. Therefore, a value of the tracker terminal can be greatly improved.

The tracker terminal includes, for example, a GNSS reception positioning device for acquiring a current location, a sensor that measures temperature, acceleration, and the like, an MCU for controlling the GNSS reception positioning device and the sensor, and a wireless communication device used for uploading acquired location information and the like and used for acquiring various kinds of setting information.

The tracker terminal uploads location information or measurement result information acquired using a GNSS function or the sensor to the server 11.

A user of the tracking service can check a location or a route of the tracker terminal referring to, for example, information registered in the database of the server 11.

Most of tracker terminals are products that operate with limited power using a built-in battery. However, among power consumptions of the products, a ratio of power consumption by the wireless communication device is higher compared with those of the GNSS reception positioning device, the sensor, and the MCU.

For this reason, reducing wasteful power consumption of the wireless communication device is highly effective in reducing the power consumption of the entire tracker terminal and greatly contributes to extension of an operation time.

Here, as a case in which wasteful power consumption of the wireless communication device occurs, it is assumed that, for example, communication was attempted by energizing the wireless communication device in order to upload in an environment in which communication with the base station cannot be performed or an environment in which the communication is difficult, but the upload was not successfully performed or the communication time was longer than necessary although the upload was successfully performed.

However, usually, it is often impossible to determine whether upload is possible unless the wireless communication device is operated to attempt connection to the base station and subsequent upload and, in order to make the determination explained above, the tracker terminal needs to attempt upload every time.

In the present embodiment, in order to solve the problems described above, it is determined whether execution of upload is possible with reference to communication area information including a communicable area or an incommunicable area retained on the inside of the tracker terminal and location information acquired by the GNSS function and whether to execute upload communication is controlled according to a result of the determination. Accordingly, it is possible to reduce opportunities of wasteful communication.

In the present embodiment, the server 11 constructs communication area information referring to a result of upload communication executed by the tracker terminal operated in the tracking service. The tracker terminal can acquire and use the communication area information provided from the server 11.

As explained above, the tracker terminal having the GNSS function attached to a delivered material or the like receives communication area information concerning a communication environment with the server 11 concerning a route or the like for transporting the material and, when transmitting location information to the server 11, determines based on the communication area information whether the current location is a location where the communication environment is bad. When the current location is a location where the communication environment is bad, the tracker terminal performs control not to communicate with the server 11.

As explained above, in the present embodiment, data communication efficiency of the tracker terminal can be improved.

Here, problems of the technique of WO 2009/157076 are explained.

That is, in a relation between the location of a satellite that transmits a GPS signal and the location of a receiver, a reception situation of the GPS signal and location measurement quality are affected by a surrounding environment such as presence or absence of a shielding object in the line-of-sight direction of the receiver. On the other hand, as a transmission and reception situation in a network of data communication, communication quality is affected by the distance between the base station and the receiver, the influence of the base station and the shielding object, and the like.

For this reason, even when the reception situation of the GPS signal is satisfactory, the environment f the data communication is not always satisfactory. For example, in a place where the sky is open, such as a mountain area, the place is satisfactory as a reception environment of the GPS signal but the data communication is impossible when there is no base station for wireless communication near the receiver. In this case, for example, the receiver consumes wasteful power by causing the wireless communication device to operate in order to attempt the data communication with the server, although the environment of the data communication is bad. For example, in a place such as a semi-indoor place in an urban area, it is difficult for the receiver to receive a GPS signal but the place is sometimes an environment in which the data communication is satisfactory. In this case, it is assumed that the receiver misses an opportunity of the data communication and a deviation between an actual communication situation and a communication situation registered in the server occurs.

In contrast, in the present embodiment, the problems described above can be solved.

In the present embodiment, in a tracker terminal mounted with a receiver such as GNSS and a wireless communication device, efficient data communication can be performed concerning wireless communication performed by the wireless communication device, and power consumption can be reduced.

In the present embodiment, for example, instead of a configuration in which communication information is determined using a reception environment of a GNSS signal from a GNSS satellite, communication area information indicating communication possible or communication impossible is constructed based on past results of data communication actually performed by a tracker terminal at each location or near the location. By referring to such communication area information, the tracker terminal can perform efficient data communication by, for example, executing the data communication only in a place where communication is possible or avoiding the data communication in a place where communication is impossible.

In the present embodiment, the tracker terminal is capable of using communication area information generated based on communication information of another tracker terminal.

Note that, for example, concerning an area where communication is possible, it is likely that location coordinates of the base station can be predicted to some extent. However, since the communication information is also affected by an environment such as a terrain, communication area information generated from an actual communication result has higher reliability.

In the present embodiment, location information is included in data uploaded by the tracker terminal, and the server 11 can specify, referring to the received data, a location where the upload was successful or a location where the upload as unsuccessful. In this case, the server 11 may refer to, for example, a relation between a positioning hour and an upload hour or content of the upload data.

As an example, the server 11 can estimate an wherein communication is possible and generate a area communicable area by aggregating, for each location such as a predetermined region, information concerning communication success acquired from one or a plurality of tracker terminals.

In this case, the tracker terminal acquires the communication area information explained above and collates a location of the tracker terminal positioned at the current time or near time and a communicable area based on the communication area information. The tracker terminal can avoid wasteful communication by determining whether the location of the tracker terminal is the inside the communicable area and control, according to a result of the determination, whether to execute data communication.

As another example, when the tracker terminal attempted upload after acquiring the information of the location of the tracker terminal and failed, the tracker terminal gives an attribute of communication failure to data including information concerning the location where the upload was unsuccessful and retains the data on the inside of the tracker terminal. The tracker terminal uploads the data to the server 11 through the next and subsequent data communication.

The server 11 can estimate an area where communication is impossible and generate an incommunicable area by aggregating the uploaded information concerning the location where communication was unsuccessful.

In this case, the tracker terminal acquires the communication area information explained above and collates the location of the tracker terminal measured at the current time or near time and the incommunicable area based on the communication area information. The tracker terminal can avoid wasteful communication by determining whether the location of the tracker terminal is the inside of the incommunicable area and controlling, according to a result of the determination, whether to execute data communication.

In the present embodiment, for example, compared with a case in which the tracker terminal performs upload according to the related art or a case in which the tracker terminal performs periodic upload regardless of an area, it is possible to reduce the number of times of failing in upload data communication and improve communication efficiency. Accordingly, it is possible to reduce power consumption of the tracker terminal and extend a power life.

In order to reduce a time lag between a situation of the tracker terminal and the data registered in the server 11, it is necessary to increase a frequency of upload of the tracker terminal. However, when this is performed, the upload frequently occurs even in an area where communication is impossible and the tracker terminal is considered to sometimes consume electric power more than necessary. In contrast, in the present embodiment, it is possible to reduce unnecessary power consumption by the tracker terminal.

In the present embodiment, by reducing unnecessary power consumption in the tracker terminal, for example, it is possible to extend an operating time of the tracker terminal with the same battery size as the battery size of the related art or to reduce the battery size compared with the related art to reduce the size of a product and expand a usable range by improving a degree of freedom in design.

Configuration examples according to the embodiment are explained.

As a configuration example, a control method for an information processing system includes the following steps.

Here, the information processing system includes a first terminal configured to acquire first location information, a second terminal configured to acquire second location information, and a server configured to set, according to communication with the first terminal, as a specific area, an incommunicable area where communication with the second terminal is not performed or a communicable area where communication with the second terminal is performed.

The control method includes: causing the first terminal to acquire the first location information; causing the first terminal to acquire communication information concerning communication with the server at a location indicated by the first location information; and causing the first terminal to transmit a communication signal including, of the first location information and the communication information, at least the first location information to the server.

The control method includes: causing the server to determine, based on the communication signal, whether communication at the location indicated by the first location information is possible or whether communication intensity satisfies a predetermined condition; causing the server to, in at least one of a case in which the server determines that a first condition that the communication is disallowed or the communication intensity is smaller than a predetermined value at the location indicated by the first location information is satisfied and a case in which the server determines that a second condition that the communication is allowed or the communication intensity is equal to or larger than the predetermined value at the location indicated by the first location information is satisfied, set the specific area including the location indicated by the first location information; and causing the server to transmit area information including information concerning the set specific area to the second terminal.

The control method includes: causing the second terminal to acquire the second location information; and at least one of, when the incommunicable area is set as the specific area including the location indicated by the first location information because the first condition is satisfied, causing the second terminal not to transmit the second location information to the server when the location indicated by the second location information is an inside of the incommunicable area and, when the communicable area is set as the specific area including the location indicated by the first location information because the second condition is satisfied, causing the second terminal to transmit the second location information to the server when the location indicated by the second location information is an inside of the communicable area.

Therefore, in the control method for the information processing system, the second terminal is controlled in an area based on a communication situation of the first terminal. That is, in the control method for the information processing system, it is possible to control the second terminal in the area based on the communication situation of the first terminal.

In the control method for the information processing system, for example, it is possible to suppress, based on the communication situation of the first terminal, communication by the second terminal in a place where communication is likely to be unsuccessful. Accordingly, it is possible to suppress wasteful communication by the second terminal and reduce power consumption in the second terminal.

In the example illustrated in FIG. 1, the information processing system 1 is an example of the information processing system, the first tracker terminal A1 is an example of the first terminal, the second tracker terminal A2 is an example of the second terminal, and the server 11 is an example of the server.

The communication information may be, for example, information capable of specifying at least one of possibility of communication and communication intensity.

For example, the communication signal may include both of the first location information and the communication information or may sometimes include the first location information but may not include the communication information.

Any value may be used as the predetermined value concerning the communication intensity and, for example, the predetermined value may be set in advance.

In the causing the server to determine, based on the communication signal from the first terminal, whether communication at the location indicated by the first location information is possible or whether communication intensity satisfies a predetermined condition, for example, the server may be caused to determine whether the communication is possible or whether the communication intensity satisfies the predetermined condition.

Possibility of communication may be determined, for example, by receiving the communication signal from the first terminal.

Negation of communication may be determined, for example, by receiving communication information indicating to that effect from the first terminal.

Note that the negation of communication may be referred to as, for example, impossibility of communication.

For example, the intensity of radio waves received by the first terminal from the base station may be used as the communication intensity and, in this case, communication information including communication intensity may be transmitted from the first terminal to the server.

The specific area may include, for example, only any one of the communicable area and the incommunicable area or may include both of the communicable area and the incommunicable area.

For example, when both of the communicable area and the incommunicable area are used and there is an area that does not belong to both of the communicable area and the incommunicable area, the second terminal may attempt communication or may not perform communication in the area.

As a configuration example, the control method for the information processing system includes at least one of: when the incommunicable area is set as the specific area including the location indicated by the first location information because the first condition is satisfied, causing the second terminal not to transmit the second location information to the server when the location indicated by the second location information is the inside of the incommunicable area and, on the other hand, causing the second terminal to transmit the second location information to the server when the location indicated by the second location information is an outside of the incommunicable area: and, when the communicable area is set as the specific area including the location indicated by the first location information because the second condition is satisfied, causing the second terminal to transmit the second location information to the server when the location indicated by the second location information is the inside of the communicable area and, on the other hand, causing the second terminal not to transmit the second location information to the server when the location indicated by the second location information is an outside of the communicable area.

Therefore, in the control method for the information processing system, concerning the communication by the second terminal, it is possible to define whether to communicate between the inside and the outside of the incommunicable area or whether to communicate between the inside and the outside of the communicable area.

As a configuration example, the control method for the information processing system causes the first terminal to set a failure in communication with the server as communication information and to transmit the acquired first location information and the communication information to the server at other timing.

Therefore, in the control method for the information processing system, when the first terminal fails in communication with the server, the first location information at that time can be notified to the server. Accordingly, in the server, for example, it is possible to set an area including a location where communication by the first terminal is unsuccessful.

As a configuration example, when the second terminal is incommunicable with the server on the outside of the incommunicable area set because the first condition is satisfied, the control method for the information processing system causes the server to reset the specific area based on the second terminal being incommunicable.

In addition, when the second terminal is incommunicable with the server on the inside of the communicable area set because the second condition is satisfied, the control method for the information processing system causes the server to reset the specific area based on the second terminal being incommunicable.

Therefore, in the control method for the information processing system, when, for example, a communication environment has changed, it is possible to maintain the accuracy of the information concerning the specific area high by resetting the specific area. As explained above, the server is capable of reviewing setting content of an area with new information.

The review of the specific area may be referred to as, for example, update of the specific area.

As a configuration example, the control method for the information processing system causes the server to set the specific area using map information stored in the server.

Therefore, in the control method for the information processing system, it is possible to set an area including roads and the like.

As a configuration example, the control method for the information processing system causes the server to manage a delivery base of the second terminal and to set the specific area when the delivery base of the second terminal is present in a direction of a delivery base to which the first terminal was delivered.

Therefore, in the control method for the information processing system, for example, when a delivery direction of the second terminal is different from delivery direction of the first terminal, it is possible not to set an area other than an area corresponding to the delivery direction of the second terminal. Accordingly, in the control method for the information processing system, an unnecessary area may not be set in the second terminal and, for example, it is possible to prevent oppression on a storage unit of the second terminal.

The delivery base of the first terminal may be, for example, a delivery base for delivery performed by a tracking target vehicle or the like to which the first terminal is attached.

Similarly, the delivery base of the second terminal may be, for example, a delivery base for delivery performed by a tracking target vehicle or the like to which the second terminal is attached.

A case in which delivery bases are different directions is, for example, a case in which the delivery direction of the first terminal is a direction from the Kanto region to the Tohoku region and the delivery direction of the second terminal is a direction from the Kanto region to the Kansai region.

As a configuration example, the control method for the information processing system causes the second terminal to change, based on an action history of the second terminal, a range of the specific area stored in the second terminal.

Therefore, in the control method for the information processing system, for example, it is possible to narrow the range of the specific area stored in the second terminal to be an area corresponding to the action history of the second terminal. Accordingly, in the control method for the information processing system, an unnecessary area may not be set in the second terminal and, for example, it is possible to prevent oppression on a storage unit of the second terminal.

As a configuration example, the control method for the information processing system causes the second terminal to set, as nonuse, the specific area for which a predetermined period has elapsed from a reference time corresponding to the specific area.

Therefore, in the control method for the information processing system, by setting an old specific area as nonuse, for example, it is possible to update the specific area stored in the second terminal to the latest specific area to correspond to the likelihood of a change in a communication environment.

As a configuration example, the control method for the information processing system performs the following processing.

Here, the information processing system sets a specific area corresponding to communication between the first terminal and the server in the second terminal using the server, the first terminal, and the second terminal.

The control method acquires first location information of the first terminal and acquires communication information concerning communication between the server and the first terminal at a location indicated by the first location information of the first terminal.

In addition, in at least one of a case in which it is determined that a first condition that the communication is disallowed or communication intensity of the communication is smaller than a predetermined value is satisfied at the location indicated by the first location information and a case in which it is determined that the communication is allowed or a second condition that the communication intensity is equal to or larger than the predetermined value is satisfied at the location indicated by the first location information, the control method sets, according to the acquired communication information, a specific area including the location indicated by the first location information.

The control method executes at least one of not causing the second terminal to communicate with the server when the second terminal is located on the inside of an incommunicable area that is a specific area set because the first condition is satisfied and causing the second terminal to communicate with the server when the second terminal is located on the inside of a communicable area that is a specific area set because the second condition is satisfied.

Therefore, in the control method for the information processing system, the second terminal is controlled in an area based on a communication situation of the first terminal. That is, in the control method for the information processing system, it is possible to control the second terminal in the area based on the communication situation of the first terminal.

The setting of the specific area may be performed by, for example, the server, may be performed by the first terminal, or may be performed by both of the server and the first terminal.

As a configuration example, the information processing system has the following configuration.

That is, the information processing system includes: a first terminal configured to acquire first location information; a second terminal configured to acquire second location information; and a server configured to set, according to communication with the first terminal, as a specific area, an incommunicable area where communication with the second terminal is not performed or a communicable area where communication with the second terminal is performed.

The first terminal: acquires the first location information; acquires communication information concerning communication with the server at a location indicated by the first location information; and transmits a communication signal including, of the first location information and the communication information, at least the first location information to the server.

The server: determines, based on the communication signal, whether communication at the location indicated by the first location information is possible or whether communication intensity satisfies a predetermined condition.

In at least one of a case in which the server determines that a first condition that the communication is disallowed or the communication intensity is smaller than a predetermined value at the location indicated by the first location information is satisfied and a case in which the server determines that a second condition that the communication is allowed or the communication intensity is equal to or larger than the predetermined value at the location indicated by the first location information is satisfied, the server sets the specific area including the location indicated by the first location information.

The server transmits area information including information concerning the set specific area to the second terminal.

The second terminal acquires the second location information.

The second terminal executes at least one of, when the incommunicable area is set as the specific area including the location indicated by the first location information because the first condition is satisfied, not transmitting the second location information to the server when the location indicated by the second location information is an inside of the incommunicable area or, when the communicable area is set as the specific area including the location indicated by the first location information because the second condition is satisfied, transmitting the second location information to the server when the location indicated by the second location information is an inside of the communicable area.

Therefore, control method for the information processing system, the second terminal is controlled in an area based on a communication situation of the first terminal. That is, the information processing system can control the second terminal in the area based on the communication situation of the first terminal.

A program for implementing the function of any constituent unit in any device explained above may be recorded in a computer-readable recording medium and the program may be executed by causing a computer system to read the program. The “computer system” referred to here includes an operating system or hardware such as peripheral equipment. The “computer-readable recording medium” is a portable medium such as a flexible disc, a magneto-optical disc, a read only memory (ROM), or a compact disc (CD)-ROM or a storage device such as a hard disk incorporated in the computer system. The “computer-readable recording medium” includes a recording medium that retains a program for a certain period of time like a volatile memory on the inside of the computer system serving as a server or a client when the program is transmitted via a network such as the Internet or a communication line such as a telephone line. The volatile memory may be a RAM. The recording medium may be a non-transitory recording medium.

The program explained above may be transmitted from a computer system in which the program is stored in a storage device or the like to another computer system via a transmission medium or by a transmission wave in the transmission medium. The “transmission medium” for transmitting the program refers to a medium having a function of transmitting information like a network such as the Internet or a communication line such as a telephone line.

The program explained above may be a program for implementing some of the functions explained above. The program explained above may be a program that can implement the functions explained above in combination with a program already recorded on the computer system, a so-called differential file. The differential file may be called differential program.

The function of any constituent unit in any device explained above may be implemented by a processor. The kinds of processing in the embodiment may be implemented by a processor that operates based on information such as a program and a computer-readable recording medium that stores the information such as the program. In the processor, the functions of the units may be implemented by individual hardware or the functions of the units may be implemented by integrated hardware. The processor may include hardware and the hardware may include at least one of a circuit that processes a digital signal and a circuit that processes an analog signal. The processor may be configured using one or both of one or a plurality of circuit devices implemented on a circuit board and one or a plurality of circuit elements. An integrated circuit (IC) or the like may be used as the circuit device and a resistor, a capacitor, or the like may be used as the circuit element.

The processor may be a CPU. However, the processor is not limited to the CPU, and various processors such as a graphics processing unit (GPU) or a digital signal processor (DSP) may be used. The processor may be a hardware circuit by an application specific integrated circuit (ASIC). The processor may include a plurality of CPUs or may include a hardware circuit by a plurality of ASICS. The processor may include a combination of a plurality of CPUs and a hardware circuit by a plurality of ASICS. The processor may include one or more of an amplifier circuit, a filter circuit, and the like that process an analog signal.

While the embodiment is explained in detail above with reference to the drawings, a specific configuration is not limited to the embodiment and includes design and the like in a range not departing from the gist of the present disclosure.

### Appendices

Configuration examples 1 to 10 are explained below.

A lower-order configuration example may or may not be applied to a higher-order configuration example.

A lower-order configuration example applicable to any one of two or more higher-order configuration examples may be applied to any configuration example among the two or more higher-order configuration examples and, when there are two or more application examples in this way, a configuration example lower in order than the lower-order configuration example may be applied to any application example among the two or more application examples.

### Configuration Example 1

A control method for an information processing system including: a first terminal configured to acquire first location information; a second terminal configured to acquire second location information; and a server configured to set, according to communication with the first terminal, as a specific area, an incommunicable area where communication with the second terminal is not performed or a communicable area where communication with the second terminal is performed, the control method including:
causing the first terminal to acquire the first location information;
causing the first terminal to acquire communication information concerning communication with the server at a location indicated by the first location information;
causing the first terminal to transmit a communication signal including, of the first location information and the communication information, at least the first location information to the server;
causing the server to determine, based on the communication signal, whether communication at the location indicated by the first location information is possible or whether communication intensity satisfies a predetermined condition;
causing the server to, in at least one of a case in which the server determines that a first condition that the communication is disallowed or the communication intensity is smaller than a predetermined value at the location indicated by the first location information is satisfied and a case in which the server determines that a second condition that the communication is allowed or the communication intensity is equal to or larger than the predetermined value at the location indicated by the first location information is satisfied, set the specific area including the location indicated by the first location information;
causing the server to transmit area information including information concerning the set specific area to the second terminal;
causing the second terminal to acquire the second location information; and
at least one of, when the incommunicable area is set as the specific area including the location indicated by the first location information because the first condition is satisfied, causing the second terminal not to transmit the second location information to the server when the location indicated by the second location information is an inside of the incommunicable area or, the communicable area is set as the specific area including the location indicated by the first location information because the second condition is satisfied, causing the second terminal to transmit the second location information to the server when the location indicated by the second location information is an inside of the communicable area.

### Configuration Example 2

The control method for the information processing system described in the configuration example 1, further including at least one of: when the incommunicable area is set as the specific area including the location indicated by the first location information because the first condition is satisfied, causing the second terminal not to transmit the second location information to the server when the location indicated by the second location information is the inside of the incommunicable area and, on the other hand, causing the second terminal to transmit the second location information to the server when the location indicated by the second location information is an outside of the incommunicable area; and, when the communicable area is set as the specific area including the location indicated by the first location information because the second condition is satisfied, causing the second terminal to transmit the second location information to the server when the location indicated by the second location information is the inside of the communicable area and, on the other hand, causing the second terminal not to transmit the second location information to the server when the location indicated by the second location information is an outside of the communicable area.

### Configuration Example 3

The control method for an information processing system described in the configuration example 1 or the configuration example 2, further including causing the first terminal to set a failure in communication with the server as communication information and transmit the acquired first location information and the communication information to the server at other timing.

### Configuration Example 4

The control method for the information processing system described in the configuration example 3, further including:
when the second terminal is incommunicable with the server on the outside of the incommunicable area set because the first condition is satisfied, causing the server to reset the specific area based on the second terminal being incommunicable; and
when the second terminal is incommunicable with the server on the inside of the communicable area set because the second condition is satisfied, causing the server to reset the specific area based on the second terminal being incommunicable.

### Configuration Example 5

The control method for the information processing system described in any one of the configuration example 1 to the configuration example 4, further including causing the server to set the specific area using map information stored in the server.

### Configuration Example 6

The control method for the information processing system described in any one of the configuration example 1 to the configuration example 5, further including causing the server to manage a delivery base of the second terminal and set the specific area when the delivery base of the second terminal is present in a direction of a delivery base to which the first terminal was delivered.

### Configuration Example 7

The control method for the information processing system described in any one of the configuration example 1 to the configuration example 6, further including causing the second terminal to change, based on an action history of the second terminal, a range of the specific area stored in the second terminal.

### Configuration Example 8

The control method for the information processing system described in any one of the configuration example 1 to the configuration example 7, further including causing the second terminal to set, as nonuse, the specific area for which a predetermined period has elapsed from a reference time corresponding to the specific area.

### Configuration Example 9

A control method for an information processing system that sets, using a server, a first terminal, and a second terminal, in the second terminal, a specific area corresponding to communication between the first terminal and the server, the control method including:
acquiring first location information of the first terminal;
acquiring communication information concerning communication between the server and the first terminal at a location indicated by the first location information of the first terminal;
in at least one of a case in which it is determined that a first condition that the communication is disallowed or communication intensity of the communication is smaller than a predetermined value at the location indicated by the first information is satisfied and a case in which it is determined that a second condition that the communication is allowed or the communication intensity is equal to or larger than the predetermined value at the location indicated by the first information, setting, according to the acquired communication information, the specific area including the location indicated by the first location information; and
executing at least one of causing the second terminal not to perform communication with the server when the second terminal is located on an inside of an incommunicable area that is the specific area set because the first condition is satisfied and causing the second terminal to perform communication with the server when the second terminal is located on an inside of a communicable area.

### Configuration Example 10

An information processing system including:
a first terminal configured to acquire first location information;
a second terminal configured to acquire second location information; and
a server configured to set, according to communication with the first terminal, as a specific area, an incommunicable area where communication with the second terminal is not performed or a communicable area where communication with the second terminal is performed, wherein
the first terminal:
   acquires the first location information;
   acquires communication information concerning communication with the server at a location indicated by the first location information; and
   transmits a communication signal including, of the first location information and the communication information, at least the first location information to the server;
the server:
   determines, based on the communication signal, whether communication at the location indicated by the first location information is possible or whether communication intensity satisfies a predetermined condition;
   in at least one of a case in which the server determines that a first condition that the communication is disallowed or the communication intensity is smaller than a predetermined value at the location indicated by the first location information is satisfied and a case in which the server determines that a second condition that the communication is allowed or the communication intensity is equal to or larger than the predetermined value at the location indicated by the first location information is satisfied, sets the specific area including the location indicated by the first location information; and
   transmits area information including information concerning the set specific area to the second terminal; and
the second terminal:
   acquires the second location information; and
   executes at least one of, when the incommunicable area is set as the specific area including the location indicated by the first location information because the first condition is satisfied, not transmitting the second location information to the server when the location indicated by the second location information is an inside of the incommunicable area or, when the communicable area is set as the specific area including the location indicated by the first location information because the second condition is satisfied, transmitting the second location information to the server when the location indicated by the second location information is an inside of the communicable area.

What is claimed is:

1. A control method for an information processing system including: a first terminal configured to acquire first location information; a second terminal configured to acquire second location information; and a server configured to set, according to communication with the first terminal, as a specific area, an incommunicable area where communication with the second terminal is not performed or a communicable area where communication with the second terminal is performed, the control method including:
causing the first t terminal to acquire the first location information;
causing the first terminal to acquire communication information concerning communication with the server at a location indicated by the first location information;
causing the first terminal to transmit a communication signal including, of the first location information and the communication information, at least the first location information to the server;
causing the server to determine, based on the communication signal, whether communication at the location indicated by the first location information is possible or whether communication intensity satisfies a predetermined condition;
causing the server to, in at least one of a case in which the server determines that a first condition that the communication is disallowed or the communication intensity is smaller than a predetermined value at the location indicated by the first location information is satisfied and a case in which the server determines that a second condition that the communication is allowed or the communication intensity is equal to or larger than the predetermined value at the location indicated by the first location information is satisfied, set the specific area including the location indicated by the first location information;
causing the server to transmit area information including information concerning the set specific area to the second terminal;
causing the second terminal to acquire the second location information; and
at least one of, when the incommunicable area is set as the specific area including the location indicated by the first location information because the first condition is satisfied, causing the second terminal not to transmit the second location information to the server when the location indicated by the second location information is an inside of the incommunicable area or, when the communicable area is set as the specific area including the location indicated by the first location information because the second condition is satisfied, causing the second terminal to transmit the second location information to the server when the location indicated by the second location information is an inside of the communicable area.

2. The control method for the information processing system according to claim 1, further comprising at least one of: when the incommunicable area is set as the specific area including the location indicated by the first location information because the first condition is satisfied, causing the second terminal not to transmit the second location information to the server when the location indicated by the second location information is the inside of the incommunicable area and, on the other hand, causing the second terminal to transmit the second location information to the server when the location indicated by the second location information is an outside of the incommunicable area; and, when the communicable area is set as the specific area including the location indicated by the first location information because the second condition is satisfied, causing the second terminal to transmit the second location information to the server when the location indicated by the second location information is the inside of the communicable area and, on the other hand, causing the second terminal not to transmit the second location information to the server when the location indicated by the second location information is an outside of the communicable area.

3. The control method for the information processing system according to claim 1, further comprising causing the first terminal to set a failure in communication with the server as communication information and transmit the acquired first location information and the communication information to the server at other timing.

4. The control method for the information processing system according to claim 3, further comprising:
when the second terminal is incommunicable with the server on the outside of the incommunicable area set because the first condition is satisfied, causing the server to reset the specific area based on the second terminal being incommunicable; and
when the second terminal is incommunicable with the server on the inside of the communicable area set because the second condition is satisfied, causing the server to reset the specific area based on the second terminal being incommunicable.

5. The control method for the information processing system according to claim 1, further comprising causing the server to set the specific area using map information stored in the server.

6. The control method for the information processing system according to claim 1, further comprising causing the server to manage a delivery base of the second terminal and set the specific area when the delivery base of the second terminal is present in a direction of a delivery base to which the first terminal was delivered.

7. The control method for the information processing system according to claim 1, further comprising causing the second terminal to change, based on an action history of the second terminal, a range of the specific area stored in the second terminal.

8. The control method for the information processing system according to claim 1, further comprising causing the second terminal to set, as nonuse, the specific area for which a predetermined period has elapsed from a reference time corresponding to the specific area.

9. A control method for an information processing system that sets, using a server, a first terminal, and a second terminal, in the second terminal, a specific area corresponding to communication between the first terminal and the server, the control method including:
acquiring first location information of the first terminal;
acquiring communication information concerning communication between the server and the first terminal at a location indicated by the first location information of the first terminal;
in at least one of a case in which it is determined that a first condition that the communication is disallowed or communication intensity of the communication is smaller than a predetermined value at the location indicated by the first information is satisfied and a case in which it is determined that a second condition that the communication is allowed or the communication intensity is equal to or larger than the predetermined value at the location indicated by the first information, setting, according to the acquired communication information, the specific area including the location indicated by the first location information; and
executing at least one of causing the second terminal not to perform communication with the server when the second terminal is located on an inside of an incommunicable area that is the specific area set because the first condition is satisfied and causing the second terminal to perform communication with the server when the second terminal is located on an inside of a communicable area.

10. An information processing system including:
a first terminal configured to acquire first location information;
a second terminal configured to acquire second location information; and
a server configured to set, according to communication with the first terminal, as a specific area, an incommunicable area where communication with the second terminal is not performed or a communicable area where communication with the second terminal is performed, wherein
the first terminal:
acquires the first location information;
acquires communication information concerning communication with the server at a location indicated by the first location information; and
transmits a communication signal including, of the first location information and the communication information, at least the first location information to the server;
the server:
determines, based on the communication signal, whether communication at the location indicated by the first location information is possible or whether communication intensity satisfies a predetermined condition;
in at least one of a case in which the server determines that a first condition that the communication is disallowed or the communication intensity is smaller than a predetermined value at the location indicated by the first location information is satisfied and a case in which the server determines that a second condition that the communication is allowed or the communication intensity is equal to or larger than the predetermined value at the location indicated by the first location information is satisfied, sets the specific area including the location indicated by the first location information; and
transmits area information including information concerning the set specific area to the second terminal; and
the second terminal:
acquires the second location information; and
executes at least one of, when the incommunicable area is set as the specific area including the location indicated by the first location information because the first condition is satisfied, not transmitting the second location information to the server when the location indicated by the second location information is an inside of the incommunicable area or, when the communicable area is set as the specific area including the location indicated by the first location information because the second condition is satisfied, transmitting the second location information to the server when the location indicated by the second location information is an inside of the communicable area.
